(19) United States
(12) Patent Application Publication
(10) Pub. No.: US 2024/0350354 A1
(43) Pub. Date: Oct. 24, 2024

(54) MECHANICAL CHEST COMPRESSION SYSTEMS AND METHODS WITH ACTIVE COMPRESSION AND DECOMPRESSION

(71) Applicant: ZOLL Medical Corporation, Chelmsford, MA (US)

(72) Inventors: Gary A. Freeman, Waltham, MA (US); Paolo Giacometti, North Grafton, MA (US); Jonathan P. Jaeb, Hudson, NH (US); George M. Reilly, Chelmsford, MA (US); Casey Schaible, Salem, NH (US)

(21) Appl. No.: 18/619,260

(22) Filed: Mar. 28, 2024

Related U.S. Application Data
(60) Provisional application No. 63/493,497, filed on Mar. 31, 2023.

(51) Int. Cl. A61H 31/00

(52) U.S. Cl. CPC A61H 31/005

(57) ABSTRACT

A mechanical chest compression system for performing cardiopulmonary resuscitation includes a resuscitation device and a controller operatively coupled to the resuscitation device. The resuscitation device includes a base, a contact portion configured to be in a superposed relation with an anterior surface of a patient when the patient is disposed on the base, and a force sensor configured to generate a force signal during compression and decompression of the anterior surface of the patient. In particular, the contact portion is movable relative to the base to provide compression and decompression to the anterior surface of the patient. The controller includes a processor configured to receive the force signal generated by the force sensor; estimate chest compliance relationship using the force signal; and generate instructions using the chest compliance relationship to drive the contact portion to provide compression and decompression to the anterior surface of the patient.

### TECHNICAL FIELD

The present disclosure relates generally to cardiopulmonary resuscitation chest compression devices.

### BACKGROUND

In the event of a cardiac arrest, several measures have been deemed to be essential in order to improve a patient's chance of survival. Cardiopulmonary Resuscitation (CPR) is an example of an activity that must be taken as soon as possible in the event of a cardiac arrest to at least partially restore the patient's respiration and blood circulation. CPR is a collection of therapeutic interventions designed to both provide blood flow via external manipulation of the external surface of the patient (e.g. thorax, abdomen, legs) as well as oxygenate the patient's blood, typically via delivery of external oxygen and other gases to the patient's lungs.

Chest compression during CPR is used to mechanically support circulation in subjects with cardiac arrest, by maintaining blood circulation and oxygen delivery until the heart is restarted. A patient's chest is compressed by a rescuer, ideally at a rate and depth of compression in accordance with medical guidelines, e.g., the American Heart Association (AHA) guidelines.

Traditional chest compressions are performed by the rescuer by laying the patient on their back, placing the rescuer's two hands on the patient's sternum and then compressing the sternal area downward towards the patient's spine in an anerior-posterior direction with an applied downward force. The rescuer then raises their hands upwards and releases them from the patient's sternal area, and the chest is allowed to expand by its natural elasticity that causes expansion of the patient's chest wall. The rescuer then repeats this down-and-up motion in a cyclical, repetitive fashion at a rate sufficient to generate adequate blood flow from the heart to other parts of the body. Accordingly, there is a continuing need for improved devices and methods for performing CPR.

### SUMMARY

In accordance with an aspect of the present disclosure, there is provided a mechanical chest compression system for performing cardiopulmonary resuscitation. The mechanical chest compression system includes a resuscitation device and a controller that is operatively coupled to the resuscitation device. The resuscitation device includes a base, a contact portion configured to be in a superposed relation with an anterior surface of a patient when the patient is disposed on the base, and a force sensor configured to generate a force signal during compression and decompression of the anterior surface of the patient. The contact portion is movable relative to the base to provide compression and decompression to the anterior surface of the patient. The controller includes a processor that is configured to receive the force signal generated by the force sensor; estimate chest compliance relationship using the force signal; and generate instructions using the chest compliance relationship to drive the contact portion to provide compression and decompression to the anterior surface of the patient.

In an embodiment, the controller may further include a non-transitory computer readable storage medium encoded with a computer program comprising instructions that, when executed, cause the processor to perform operations including: determining the chest compliance relationship based on force applied to the anterior surface of the patient by the contact portion detected by the force sensor, and displacement between an initial position and at least one preset position.

In another embodiment, the processor may be configured to determine a force to be applied to the anterior surface of the patient in order for the contact portion to reach a target position, based on the chest compliance relationship of the patient.

In yet another embodiment, the processor may be further configured to actuate the resuscitation device to apply the force to the anterior surface of the patient to move the contact portion to the target position.

In still yet another embodiment, a distance between the initial position and the target position may have a range between about 2.0 and 2.4 inches (about 51 and 61 mm).

In still yet another embodiment, the contact portion may be biased towards the initial position.

In an embodiment, the resuscitation device may include at least one stop configured to inhibit axial travel of the contact portion, whereby the at least one stop is positioned to enable a preset amount of axial travel of the contact portion.

In another embodiment, the contact portion of the resuscitation device may be movable between an initial position and a preset position having a desired compression of the anterior surface of the patient.

In yet another embodiment, the processor may be configured to actuate the resuscitation device to apply a force to the anterior surface of the patient to cause axial travel of the contact portion to the preset position.

In still yet another embodiment, the resuscitation device may include a plurality of stops configured to inhibit axial travel of the contact portion, whereby each stop is positioned to enable a preset amount of axial travel of the contact portion.

In still yet another embodiment, the contact portion may be movable between an initial position and a plurality of preset positions corresponding to a desired compression of the anterior surface of the patient.

In still yet another embodiment, the controller may further include a non-transitory computer readable storage medium encoded with a computer program comprising instructions that, when executed, cause the processor to perform operations including: selecting a stop of the plurality of stops to effect a desired compression of the anterior surface of the patient; and actuating the resuscitation device to apply a force to the anterior surface of the patient to cause axial travel of the actuation arm to the one preset position. The stop may correspond to one preset position of the plurality of preset positions of the actuation arm.

In an embodiment, the resuscitation device may further include an actuation arm having the contact portion.

In another embodiment, the actuation arm may be removably attached to the patient by a patient attachment interface.

In yet another embodiment, the patient attachment interface may include a suction cup.

In still yet another embodiment, the resuscitation device may further include an outer sleeve configured to slidably receive the actuation arm therein.

In still yet another embodiment, the actuation arm may include a tooth and the outer sleeve may include a plurality of stops configured to engage the tooth of the actuation arm.

In an embodiment, the actuation arm may be rotatable relative to the outer sleeve between an engaged state, in which, the tooth of the actuation arm engages one stop of the plurality of stops of the outer sleeve, and a disengaged state, in which, the tooth of actuation arm is angularly offset from the one stop of the plurality of stops of the outer sleeve to enable axial travel of the actuation arm within the outer sleeve.

In another embodiment, the one stop of the outer sleeve may be selectively adjustable along a length of the outer sleeve.

In yet another embodiment, the actuation arm may be biased to an initial position.

In yet another embodiment, the initial position of the actuation arm may be adjustable by a user.

In still yet another embodiment, the actuation arm may include a stop and the outer sleeve may include an inner protrusion having a chamfered portion configured to engage the stop of the actuation arm.

In still yet another embodiment, the force sensor may be configured to measure force just before the stop comes in contact with the chamfered portion of the outer sleeve.

In still yet another embodiment, the stop of the actuation arm or the inner protrusion of the outer sleeve may be formed of a compressible material.

In still yet another embodiment, the resuscitation device may further include arms that are supported by the base.

In still yet another embodiment, the actuation arm may be supported by the arms.

In still yet another embodiment, a length of each arm may be selectively adjustable.

In still yet another embodiment, the resuscitation device may further include a displacement sensor.

In still yet another embodiment, the controller may further include a non-transitory computer readable storage medium encoded with a computer program comprising instructions that, when executed, cause the processor to perform operations comprising determining the chest compliance relationship based on force applied to the anterior surface of the patient by the contact portion detected by the force sensor, and displacement measured by the displacement sensor.

In an embodiment, the displacement sensor may include an accelerometer.

In accordance with another aspect of the present disclosure, there is provided a system for performing cardiopulmonary resuscitation including a resuscitation device and a controller operatively coupled to the resuscitation device. The resuscitation device includes a base, a frame including arms that are supported by the base, an actuator coupled to the frame, an actuation arm supported by the arms of the frame such that the actuation arm is in a superposed relation with an anterior surface of a patient when the patient is disposed on the base of the frame, and a force sensor coupled to the actuation arm. The actuation arm is configured to provide compression and decompression to the anterior surface of the patient. The actuation arm includes a first portion configured to be affixed to the anterior surface of the patient and a second portion operatively coupled to the actuator to impart axial travel to the first portion of the actuation arm, wherein the actuation arm is movable between an initial position, a preset position, or a target position having a desired axial travel of the first portion of the actuation arm. The controller includes a processor and a non-transitory computer readable storage medium encoded with a computer program including instructions that, when executed, cause the processor to perform operations including: determining a chest compliance relationship based on force applied to the anterior surface of the patient by the first portion of the actuation arm measured by the force sensor, and displacement between the initial position and the preset position; based on the chest compliance relationship of the patient, determining a force to be applied to the anterior surface of the patient in order for the actuation arm to reach the target position; and actuating the resuscitation device to apply the force to the anterior surface of the patient to move the actuation arm to the target position.

In an embodiment, the force sensor may be disposed in the first portion of the actuation arm.

In another embodiment, the force sensor may be disposed adjacent the second portion of the actuation arm.

In yet another embodiment, the resuscitation device may further include an outer sleeve configured to slidably receive the actuation arm therein.

In still yet another embodiment, the outer sleeve may include a stop configured to inhibit axial displacement of the actuation arm therein.

In still yet another embodiment, the actuation arm may include a tooth configured to engage the stop of the outer sleeve.

In still yet another embodiment, the actuation arm may be rotatable relative to the outer sleeve between an engaged state, in which, the tooth of the actuation arm engages the stop of the outer sleeve and a disengaged state, in which, the tooth of actuation arm is angularly offset from the stop of the outer sleeve to enable axial travel of the actuation arm within the outer sleeve.

In still yet another embodiment, the preset position of the actuation arm may correspond to an axial location of the stop on the outer sleeve.

In still yet another embodiment, the stop of the outer sleeve may be selectively adjustable along a length of the outer sleeve.

In still yet another embodiment, the actuation arm may be biased to the initial position.

In still yet another embodiment, the initial position of the actuation arm may be adjustable by a user.

In still yet another embodiment, the actuation arm may include a stop and the outer sleeve may include an inner protrusion having a chamfered portion configured to engage the stop of the actuation arm.

In still yet another embodiment, the force sensor may be configured to measure force just before the stop comes in contact with the chamfered portion.

In still yet another embodiment, the stop of the actuation arm or the inner protrusion of the outer sleeve may be formed of a compressible material.

In still yet another embodiment, the resuscitation device may further include a displacement sensor.

In still yet another embodiment, the first portion of the actuation arm may include a suction cup.

In still yet another embodiment, a distance between the initial position and the target position may have a range between about 2.0 and 2.4 inches (about 51 and 61 mm).

In still yet another embodiment, each arm may be retractable to selectively adjust a length thereof.

In still yet another embodiment, each arm may be retractable during compression.

In still yet another embodiment, the arms of the frame may be detachably coupled to the base.

In accordance with another aspect of the present disclosure, there is provided a system for performing cardiopulmonary resuscitation including a resuscitation device and a controller operatively coupled to the resuscitation device. The resuscitation device includes an actuation arm, at least one stop, and a force sensor. The actuation arm has a first portion configured to be affixed to an anterior surface of a patient. Further, the actuation arm is movable to apply compression and decompression to the patient. The at least one stop is configured to inhibit axial travel of the actuation arm, whereby the at least one stop is positioned to enable a preset amount of axial travel of the actuation arm between the initial position and the preset position. The force sensor is coupled to the actuation arm. The first portion is movable during compression and decompression between an initial position, a preset position, or a target position. The controller includes a processor and a non-transitory computer readable storage medium encoded with a computer program including instructions that, when executed, cause the processor to perform operations including: determining a chest compliance relationship involving force applied to the anterior surface of the patient by the first portion of the actuation arm, and displacement between the initial position and the preset position; based on the chest compliance relationship, determining a force to be applied to the anterior surface of the patient in order for the first portion of the actuation arm to reach the target position; and actuating the resuscitation device to apply the force to the anterior surface of the patient to move the first portion of the actuation arm to the target position.

In an embodiment, the force sensor may be disposed adjacent the first or second portion of the actuation arm.

In an embodiment, the preset position may be interposed between the initial position and the target position.

In an embodiment, the resuscitation device may further include an outer sleeve configured to slidably receive the actuation arm therein.

In an embodiment, the outer sleeve may include the at least one stop configured to inhibit axial displacement of the actuation arm therein.

In an embodiment, the actuation arm may include a tooth configured to engage the at least one stop of the outer sleeve.

In an embodiment, the actuation arm may be rotatable relative to the outer sleeve between an engaged state. The tooth of the actuation arm may engage the at least one stop of the outer sleeve and a disengaged state. The tooth of actuation arm may be angularly offset from the at least one stop of the outer sleeve to enable axial travel of the actuation arm within the outer sleeve.

In another embodiment, the preset position of the actuation arm may correspond to an axial location of the at least one stop on the outer sleeve.

In another embodiment, the at least one stop of the outer sleeve may be selectively adjustable along a length of the outer sleeve.

In an embodiment, the actuation arm may be biased to the initial position.

In an embodiment, the initial position of the actuation arm may be adjustable by a user.

In an embodiment, the actuation arm may include a stop. The outer sleeve may have an inner protrusion having a chamfered portion configured to engage the stop of the actuation arm.

In an embodiment, the force sensor may be configured to measure force just before the stop of the actuation arm comes in contact with the chamfered portion of the outer sleeve.

In an embodiment, the stop of the actuation arm or the inner protrusion of the outer sleeve may be formed of a compressible material.

In an embodiment, the resuscitation device may further include a displacement sensor.

In an embodiment, the first portion of the actuation arm may include a suction cup.

In an embodiment, a distance between the initial position and the target position may have a range between about 2.0 and 2.4 inches (about 51 and 61 mm).

In an embodiment, the resuscitation device may further include an arm supporting the actuation arm.

In an embodiment, a length of the arm may be selectively adjustable.

In an embodiment, the arm may be retractable during compression.

In accordance with another aspect of the present disclosure, there is provided a resuscitation device. There may further be provided a system for performing cardiopulmonary resuscitation including the resuscitation device and a controller operatively coupled to the resuscitation device.

The resuscitation device includes an actuator, an actuation arm positionable in a superposed relation with an anterior surface of a patient, and at least one stop configured to inhibit axial travel of the actuation arm, whereby the at least one stop is positioned to enable a preset amount of axial travel of the actuation arm. The actuation arm is movable between an initial position and a preset position having a desired compression of the anterior surface of the patient. The actuation arm is configured to provide compression and decompression to the anterior surface of the patient. The actuation arm includes a first portion configured to be affixed to the anterior surface of the patient and a second portion operatively coupled to the actuator to impart axial travel to the first portion of the actuation arm.

The controller includes a processor and a non-transitory computer readable storage medium encoded with a computer program including instructions that, when executed, cause the processor to actuate the resuscitation device to apply a force to the anterior surface of the patient to cause axial travel of the actuation arm to the preset position.

In an embodiment, the force sensor may be disposed in the first portion of the actuation arm.

In another embodiment, the force sensor may be disposed adjacent the second portion of the actuation arm.

In yet another embodiment, the resuscitation device may further include an outer sleeve configured to slidably receive the actuation arm therein.

In still yet another embodiment, the outer sleeve may include the at least one stop configured to inhibit axial displacement of the actuation arm therein.

In still yet another embodiment, the actuation arm may include a tooth configured to engage the at least one stop of the outer sleeve.

In still yet another embodiment, the actuation arm may be rotatable relative to the outer sleeve between an engaged state, in which, the tooth of the actuation arm engages the at least one stop of the outer sleeve and a disengaged state, in which, the tooth of actuation arm is angularly offset from the at least one stop of the outer sleeve to enable axial travel of the actuation arm within the outer sleeve.

In an embodiment, the preset position of the actuation arm may correspond to an axial location of the at least one stop on the outer sleeve.

In another embodiment, the at least one stop of the outer sleeve may be selectively adjustable along a length of the outer sleeve.

In yet another embodiment, the actuation arm may be biased to the initial position.

In still yet another embodiment, the initial position of the actuation arm may be adjustable by a user.

In still yet another embodiment, the actuation arm may include a stop and the outer sleeve may include an inner protrusion having a chamfered portion configured to engage the stop of the actuation arm.

In still yet another embodiment, the force sensor may be configured to measure force just before the stop comes in contact with the chamfered portion of the outer sleeve.

In still yet another embodiment, the stop of the actuation arm or the inner protrusion of the outer sleeve may be formed of a compressible material.

In still yet another embodiment, the resuscitation device may further include a displacement sensor.

In an embodiment, the first portion of the actuation arm may include a suction cup.

In another embodiment, a distance between the initial position and the preset position may have a range between about 2.0 and 2.4 inches (about 51 and 61 mm).

In yet another embodiment, the resuscitation device may further include an arm supporting the actuation arm.

In still yet another embodiment, the arm may be retractable during compression.

In still yet another embodiment, a length of the arm may be selectively adjustable.

In still yet another embodiment, the processor may be configured to further determine the force to be applied to the anterior surface of the patient in order for the actuation arm to reach the preset position.

In still yet another embodiment, the processor may be configured to determine a chest compliance relationship involving force applied to the anterior surface of the patient by the first portion of the actuation arm, and displacement between the initial position and the preset position.

In still yet another embodiment, a position of the at least one stop may correspond to the preset position.

In accordance with yet another aspect of the present disclosure, there is provided a system for performing cardiopulmonary resuscitation including a resuscitation device and a controller operatively coupled to the resuscitation device. The resuscitation device includes an actuator, an actuation arm positionable in a superposed relation with an anterior surface of a patient, and a plurality of stops configured to inhibit axial travel of the actuation arm, whereby each stop is positioned to enable a preset amount of axial travel of the actuation arm. The actuation arm is movable between an initial position and a plurality of preset positions corresponding to a desired compression of the anterior surface of the patient. The actuation arm includes a first portion configured to be affixed to the anterior surface of the patient and a second portion operatively coupled to the actuator to impart movement to the first portion of the actuation arm. The controller includes a processor and a non-transitory computer readable storage medium encoded with a computer program comprising instructions that, when executed, cause the processor to perform operations including: selecting a stop of the plurality of stops to effect a desired compression of the anterior surface of the patient, the stop corresponding to one preset position of the plurality of preset positions of the actuation arm; and actuating the resuscitation device to apply a force to the anterior surface of the patient to cause axial travel of the actuation arm to the one preset position.

In an embodiment, the resuscitation device may include a force sensor.

In another embodiment, the force sensor may be disposed adjacent the first portion or the second portion of the actuation arm.

In yet another embodiment, the resuscitation device may further include an outer sleeve configured to slidably receive the actuation arm therein.

In still yet another embodiment, the actuation arm may include a tooth configured to engage one stop of the plurality of stops.

In still yet another embodiment, the actuation arm may be rotatable relative to the outer sleeve between an engaged state, in which, the tooth of the actuation arm engages the one stop of the plurality of stops of the outer sleeve and a disengaged state, in which, the tooth of actuation arm is angularly offset from the one stop of the plurality of stops of the outer sleeve to enable axial travel of the actuation arm within the outer sleeve.

In an embodiment, the stop of the outer sleeve may be selectively adjustable along a length of the outer sleeve.

In another embodiment, the actuation arm may be biased to the initial position.

In yet another embodiment, the initial position of the actuation arm may be adjustable by a user.

In still yet another embodiment, the actuation arm may be configured to be retracted to a position proximal of the initial position.

In still yet another embodiment, the actuation arm may include a stop and the outer sleeve may include an inner protrusion having a chamfered portion configured to engage the stop of the actuation arm.

In still yet another embodiment, the force sensor may be configured to measure force just before the stop comes in contact with the chamfered portion of the outer sleeve.

In still yet another embodiment, the stop of the actuation arm or the inner protrusion of the outer sleeve may be formed of a compressible material.

In still yet another embodiment, the resuscitation device may further include a displacement sensor.

In still yet another embodiment, the first portion of the actuation arm may include a suction cup.

In still yet another embodiment, a distance between the initial position and the target position may have a range between about 2.0 and 2.4 inches (about 51 and 61 mm).

In still yet another embodiment, the resuscitation device may further include an arm supporting the actuation arm.

In still yet another embodiment, a length of the arm may be adjustable.

In still yet another embodiment, the arm may be retractable during compression.

In accordance with another aspect of the present disclosure, there is provided a method of performing cardiopulmonary resuscitation (CPR) administered to a patient. The method includes determining a chest compliance relationship of the patient based on force applied to the anterior surface of the patient by the actuation arm measured by a force sensor, and displacement between an initial position and a preset position; based on the chest compliance relationship of the patient, determining a force to be applied to the anterior surface of the patient in order for the actuation arm to reach a target position; and actuating the resuscitation device to apply the force to the anterior surface of the patient to cause axial travel of the actuation arm to the target position.

In an embodiment, determining the force may include determining the force to be applied to the patient in order for the actuation arm to be displaced no greater than about 2.4 inches (about 51 and 61 mm).

In another embodiment, the method may further include actuating the resuscitation device to apply another force to the anterior surface of the patient that is greater than the force applied to the anterior surface of the patient to cause axial travel of the actuation arm to the target position.

In yet another embodiment, the method may further include actuating the resuscitation device to apply a negative force to the anterior surface of the patient.

In yet another embodiment, determining compliance may include using a lookup table.

In yet another embodiment, determining the chest compliance relationship may include measuring force just before a stop of an actuation arm of the resuscitation device engages a peg that impedes axial travel of the actuation arm.

In yet another embodiment, determining the chest compliance relationship may include placing the peg at a preset position.

In yet another embodiment, determining the chest compliance relationship may include measuring force just before a stop of an actuation arm of the resuscitation device engages a detent mechanism.

In yet another embodiment, determining the chest compliance relationship may include measuring displacement of an actuation arm by a displacement sensor.

In accordance with another aspect of the present disclosure, there is provided a computer program product comprising computer program code that is configured to cause a processor to perform the steps disclosed by any controller described herein.

In one embodiment computer program code that is configured to cause a processor to receive a force signal indicative of a force applied to an anterior surface of a patient, receive a displacement signal indicative of displacement between an initial position and a preset position, determine a compliance relationship based on the force signal and the displacement signal, and determine a force to be applied to the anterior surface of the patient based on the chest compliance relationship of the patient. The computer program code may be configured to cause a processor to control a chest compression device in accordance with the determined force, for example by actuating the resuscitation device to apply the force to the anterior surface of the patient to cause axial travel of the actuation arm to the target position.

In accordance with another aspect of the present disclosure, there is provided a system for performing cardiopulmonary resuscitation including a resuscitation device and a controller operatively coupled to the resuscitation device. The resuscitation device includes an actuation arm, at least one stop, and a force sensor. The actuation arm has a first portion configured to be affixed to an anterior surface of a patient. The actuation arm is movable to apply compression and decompression to the patient. The at least one stop is configured to inhibit axial travel of the actuation arm, whereby the at least one stop is positioned to enable a preset amount of axial travel of the first portion of the actuation arm between the initial position and a preset position. The force sensor is operatively coupled to the actuation arm. The first portion is movable during compression from an initial position to a first target position and decompression from the first target position to a second target position. The controller includes a processor and a non-transitory computer readable storage medium encoded with a computer program comprising instructions that, when executed, cause the processor to perform operations including: determining a chest compliance relationship involving force applied to the anterior surface of the patient by the first portion of the actuation arm, and displacement between the initial position and the preset position; based on the chest compliance relationship, determining a compression force to be applied to the anterior surface of the patient in order for the first portion of the actuation arm to reach the first target position; based on the chest compliance relationship, determining a decompression force to be applied to the anterior surface of the patient in order for the first portion of the actuation arm to retract to the second target position; actuating the resuscitation device to apply the compression force to the anterior surface of the patient to cause axial displacement of the first portion of the actuation arm to the first target position to perform compression; and actuating the resuscitation device to apply the decompression force to the anterior surface of the patient to cause axial displacement of the first portion of the actuation arm to the second target position to perform decompression.

In an embodiment, the decompression force may be a negative force.

In another embodiment, the second target position may be different from the initial position.

In yet another embodiment, the second target position may be distal of the initial position.

In still yet another embodiment, the operations of the processor may further include determining a second chest compliance relationship involving a negative force applied to the anterior surface of the patient by the first portion of the actuation arm, and displacement between the initial position and a second preset position.

In still yet another embodiment, the second present position may be distal of the initial position.

In still yet another embodiment, the second preset position may be proximal of the second target position.

In still yet another embodiment, the actuation arm may be biased to the initial position.

In still yet another embodiment, the initial position of the actuation arm may be adjustable by a user.

In still yet another embodiment, the actuation arm may include a stop and the outer sleeve may include an inner protrusion having a chamfered portion configured to engage the stop of the actuation arm.

In still yet another embodiment, the force sensor may be configured to measure force just before the stop of the actuation arm comes in contact with the chamfered portion of the outer sleeve.

In still yet another embodiment, the stop of the actuation arm or the inner protrusion of the outer sleeve may be formed of a compressible material.

In still yet another embodiment, the resuscitation device may further include a displacement sensor.

In still yet another embodiment, the first portion of the actuation arm may include a suction cup.

In still yet another embodiment, a distance between the initial position and the first target position may have a range between about 2.0 and 2.4 inches (about 51 and 61 mm).

In still yet another embodiment, the resuscitation device may further include an arm that supports the actuation arm.

In still yet another embodiment, a length of the arm may be selectively adjustable.

In still yet another embodiment, the arm may be retractable during compression.

In accordance with another aspect of the present disclosure, there is provided a resuscitation device. There may further be provided a system for performing cardiopulmonary resuscitation including the resuscitation device and a controller operatively coupled to the resuscitation device.

The resuscitation device includes an actuator and an actuation assembly operatively coupled to the actuator. The actuation assembly includes a base portion, a connecting part, and a lead screw. The base portion has first arms that are spaced apart and pivotably coupled to the base portion, and a contact portion configured to impart compression or decompression to a patient. The connecting part includes second arms that are spaced apart and pivotably coupled to the connecting part, wherein the first arms are pivotably connected to respective second arms about first and second pivots that are spaced apart. The lead screw is operatively associated with the first and second arms such that rotation of the lead screw moves the first and second pivots between an approximated position, in which, the base portion and the connecting part are moved away from each other, and a spaced apart position, in which, the base portion and the connecting part are moved towards each other.

The controller includes a processor and a non-transitory computer readable storage medium encoded with a computer program comprising instructions that, when executed, cause the processor to actuate the resuscitation device to apply a force to an anterior surface of the patient to perform compression and decompression.

The worm gear may be configured to engage the worm screw to convert rotational motion of the worm screw into a linear motion of the drive screw.

In an embodiment, the resuscitation device may further include a base and a support arm coupled to the base. The support arm may be configured to support the actuation assembly.

In another embodiment, the actuation assembly may further include a flexible drive shaft operatively coupling the actuator to the lead screw.

In yet another embodiment, the actuator may be disposed on the base.

In yet another embodiment, the actuation assembly may include an adjustment bar including an elongate portion adjustably securable to the support arm.

In still yet another embodiment, the support arm may include a release clamp configured to adjustably engage the elongate portion of the adjustment bar.

In still yet another embodiment, the actuation assembly may further include a spring interposed between the release clamp and the connecting part.

In still yet another embodiment, the actuation assembly may further include a spring interposed between the first and second pivots.

In still yet another embodiment, the base and the support arm may include telescopic portions.

In accordance with another aspect of the present disclosure, there is provided a resuscitation device. There may further be provided a system for performing cardiopulmonary resuscitation including the resuscitation device and a controller operatively coupled to the resuscitation device.

The resuscitation device includes an actuator and an actuation assembly operatively coupled to the actuator. The actuation assembly includes a worm screw coupled to the actuator and configured to receive rotational output of the actuator, a worm gear configured to engage the worm screw to convert rotational output of the actuator into a linear motion, a drive screw coupled to the worm gear, and a contact portion coupled to the drive screw and configured to be affixed to a patient to impart compression and decompression to the patient.

The controller includes a processor and a non-transitory computer readable storage medium encoded with a computer program comprising instructions that, when executed, cause the processor to actuate the resuscitation device to apply a force to an anterior surface of the patient to perform compression and decompression.

The worm gear may be configured to engage the worm screw to convert rotational motion of the worm screw into a linear motion of the drive screw.

In an embodiment, the resuscitation device may further include a base and a support arm configured to support the actuation assembly.

In another embodiment, the resuscitation device may further include an actuation housing including the actuation assembly. The support arm may be adjustably coupled to the actuation housing.

In another embodiment, the contact portion of the resuscitation device may be movable between an initial position and a preset position having a desired decompression of the anterior surface of the patient.

In another embodiment, the resuscitation device includes a plurality of stops configured to inhibit axial travel of the contact portion. Each stop may be positioned to enable a preset amount of axial travel of the contact portion. The contact portion may be movable between an initial position and a plurality of preset positions corresponding to a desired decompression of the anterior surface of the patient.

According to a further aspect of the disclosure there is provided a resuscitation device comprising an actuator, an actuation assembly and a contact portion configured to be affixed to a patient. The actuator is configured to generate a rotational output. The actuation assembly is configured to receive the rotational output of the actuator and translate the rotational motion into a linear motion of the contact portion. A torque vector of the rotational output may be transverse or perpendicular to a vector of the linear motion.

In general, the resuscitation device may be separate from, or integrated with, the controller. For example, the controller may be provided in the same or a different housing to the resuscitation device. It therefore will be appreciated that the embodiment that disclose both the resuscitation device and the controller support claims directed to either the resuscitation device or the controller, as well as the overall system.

In general, an embodiment described in relation to one aspect may be provided in combination with any other aspect or embodiment.

In general, a force sensor may be configured to determine an applied compressive force. The force sensor may be provided separately from a displacement sensor.

In general, functionality of the controller that is disclosed as being implemented by a processor, or using a processor and non-transitory computer readable storage medium, or a computer program, may be implemented directly by the controller by those or other means, such as hardware only for example.

The details of one or more embodiments are set forth in the accompanying drawings and the description below. Other features and advantages will be apparent from the description and drawings, and from the claims.

### BRIEF DESCRIPTION OF THE DRAWINGS

The accompanying drawings, which are incorporated in and constitute a part of the specification, illustrate one or more embodiments and, together with the description, explain these embodiments. The above and other aspects and features of this disclosure will become more apparent in view of the following detailed description when taken in conjunction with the accompanying drawings wherein like reference numerals identify similar or identical elements. The devices disclosed herein are described in detail with reference to the drawings, in which like reference numerals designate identical or corresponding elements in each of the several views. The terms parallel and perpendicular are understood to include relative configurations that are substantially parallel and substantially perpendicular up to about + or −10 degrees from true parallel and true perpendicular. Further, to the extent consistent, any or all of the aspects detailed herein may be used in conjunction with any or all of the other aspects detailed herein. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features.

FIG. 1 is a schematic diagram of a mechanical chest compression system in accordance with an embodiment of the present disclosure.

FIG. 2 is a graph illustrating various signals recorded during CPR.

FIG. 3 is a block diagram of components of the mechanical chest compression system of FIG. 1.

FIG. 4 is a graph illustrating a chest compliance curve.

FIGS. 5 and 6 are graphs illustrating stiffness curves.

FIGS. 7-10 are schematic diagrams of the mechanical chest compression system of FIG. 1 illustrating use thereof.

FIG. 11 is a partial side cross-sectional view of an actuation assembly for use with the mechanical chest compression system of FIG. 1 in accordance with another embodiment of the present disclosure.

FIG. 11A is a graph illustrating a force curve measured by a force sensor when a stop of the actuation assembly of FIG. 11 engages a peg of an outer sleeve at respective preset positions.

FIG. 11B is a graph illustrating a compliance curve at each preset position.

FIGS. 11C-11E are graphs illustrating force curves measured by a force sensor when the stop of the actuation assembly of FIG. 11 engages a peg of an outer sleeve at respective preset positions.

FIGS. 12 and 13 are partial cross-sectional views of another actuation assembly for use with the mechanical chest compression system of FIG. 1 in accordance with another embodiment of the present disclosure.

FIG. 14 is a partial side cross-sectional view of an actuation assembly for use with the mechanical chest compression system of FIG. 1 in accordance with another embodiment of the present disclosure.

FIG. 15 is a cross-sectional view of a mechanical chest compression system in accordance with another embodiment of the present disclosure.

FIG. 16 is a cross-sectional view of the mechanical chest compression system of FIG. 15, illustrating use thereof.

FIG. 17 is a perspective view of a release clamp of a support arm of the mechanical chest compression system of FIG. 16.

FIG. 18 is a side view of an actuation assembly of the mechanical chest compression system of FIG. 16.

FIG. 18A is a side view of an actuation assembly in accordance with another embodiment of the present disclosure.

FIG. 19 is a cross-sectional view of a mechanical chest compression system in accordance with another embodiment of the present disclosure.

FIG. 20 is a cross-sectional view of another linkage assembly for use with the mechanical chest compression system of FIG. 16 in accordance with another embodiment of the present disclosure.

FIG. 21 is a cross-sectional view of a mechanical chest compression system in accordance with yet another embodiment of the present disclosure.

FIG. 22 is a cross-sectional is a side view of a mechanical chest compression system in accordance with still yet another embodiment of the present disclosure.

FIG. 23 is a perspective view of a support frame of the mechanical chest compression system of FIG. 22.

FIG. 23A is a perspective view of a support frame and a base in accordance with another embodiment of the present disclosure.

FIG. 23B is a perspective view of the support frame and the base of FIG. 23A with a compression device removed, illustrating collapsibility of the support frame.

FIGS. 24 and 25 are side cross-sectional views of a lock of the mechanical chest compression system of FIG. 22, illustrating use thereof.

FIG. 26 is a perspective view of a mechanical chest compression system according to another embodiment of the present disclosure.

FIG. 27 is a side cross-sectional view of an actuation housing of the mechanical chest compression system of FIG. 26.

FIG. 28 is a side cross-sectional view of a linkage assembly of the actuation housing of FIG. 27.

FIG. 29 is a partial perspective view of an adjustment assembly of the mechanical chest compression system of FIG. 26 with a portion of an inner wall of the actuation housing removed.

FIG. 30 is another partial perspective view of the adjustment assembly, illustrating engagement of a locking bar of the adjustment assembly against the inner wall of the actuation housing.

FIGS. 31 and 32 are cross-sectional views of the mechanical chest compression system of FIG. 26, illustrating use of the adjustment assembly.

FIG. 33 is a cross-sectional view of a mechanical chest compression system in accordance with another embodiment of the present disclosure.

FIG. 34 is a perspective view of an actuation assembly of the mechanical chest compression system of FIG. 33.

FIG. 35 is a block diagram of an example computer system.

### DETAILED DESCRIPTION

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

Described herein is a mechanical chest compression system for performing cardiopulmonary resuscitation (CPR). The mechanical chest compression system may utilize a force sensor to generate a force signal during compression and decompression of an anterior surface of the patient. The mechanical chest compression system may further include a processor that is configured to estimate chest compliance relationship using the force signal and generate instructions using the chest compliance relationship to drive a contact portion to provide compression and decompression to the anterior surface of the patient.

Chest compliance relationship is a measure of the ability of the chest to absorb an applied force and change shape in response to the force. Each patient requires a unique amount of force to achieve the same compression of the sternum and the cardiopulmonary system due to the widely varying compliances of individual patients' chests. In the context of CPR, information about chest compliance may be used to determine how force can be applied to the chest of a patient in a way that will be effective at resuscitating the patient. Ideally, the compression force applied to the patient will be sufficient to force blood to flow out of the heart, and the decompression force will be sufficient to create a vacuum within the heart to enhance venous return of blood to the heart. However, if the decompression force is not sufficient to create this vacuum, CPR may not be effective which may reduce the survival rate of the patient. Further, if the compression or decompression force is not applied correctly or is excessive, the patient may suffer an injury. By using the chest compliance relationship in providing compression and decompression, the mechanical chest compression system described herein ensures sufficient force is applied to the patient for effective CPR, while reducing risk of injury to the patient. Furthermore, chest compliance will typically increase significantly as the sternum/cartilage/rib biomechanical system is substantially flexed and stressed. Thus, the amount of force needed to displace the sternum to the proper compression and decompression depths will also change significantly. The mechanical chest compression system disclosed herein may periodically update or calibrate chest compliance during CPR to reduce the risk of injury to the patient.

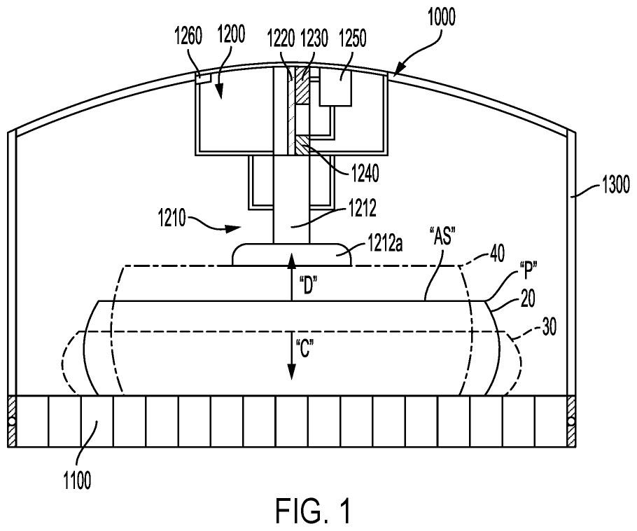

In addition, the mechanical chest compression system may also include an actuation assembly having, e.g., a scissor jack configuration or a screw jack configuration, that provides mechanical advantage. Under such a configuration, the amount of axial travel of the contact portion in the anterior-posterior direction (e.g., as shown by arrows “C” and “D” in FIG. 1), may be reduced, which, in turn, may reduce the height of the mechanical chest compression system. Such a configuration enhances stability as well as portability of the mechanical chest compression system. Further, the mechanical chest compression system may provide improved stability through strategic placement of the components, e.g., by lowering the center of mass of the mechanical chest compression system.

Further, other advantages of the mechanical chest compression system may include CPR continuity during transport; consistent guideline-compliant therapy during long resuscitations or during resuscitations with few caregivers; and reduced staffing requirements allowing caregivers to focus on other therapies or treatments, such as trying to address underlying cause of arrest, manual ventilation, or other injuries that may have been caused by the arrest. In a pediatric case, the mechanical chest compression system may enable absolute measurement of patient anterior-posterior distance, allowing for therapy targets to be calculated rather than having to be estimated by the caregiver. In the case of active compression decompression (ACD) CPR, it has been shown to reduce the amount of chest deformation and increase compliance of the biomechanics system and therefore allowing for more effective heart filling and emptying (by not permitting the biomechanics system to collapse during CPR and by not remodeling the chest wall to increase the potential rib and organ damage caused by CPR as well as the potential misapplication of therapy resulting from deeper compressions than may have been originally indicated (neutral point lowering)).

Additional advantages may include potential for closed loop CPR (varying therapy targets based on physiological metrics quantifying CPR effectiveness). Other advantages may include synchronization of CPR compression and monitor defibrillator (e.g. communicating to the monitor when pauses start to enable ECG analysis and/or shock, or prompting for ventilations, while minimizing the CPR pause times), and synchronization with mechanical ventilation to enable ventilations during CPR or during pauses. The mechanical chest compression system may include the ability to vary the CPR waveform duty cycle, waveform shape, or hold times, allowing for optimized and personalized CPR compressions. Other advantages that could be enabled by mechanical CPR is implementation of ramp-up CPR methods for both compression and lift. In fact, ramp up CPR could be done both in a predetermined or compliance-dependent manner to minimize non-compliant CPR.

The present disclosure describes various mechanical chest compression systems that demonstrate a practical approach to meeting the performance requirements and overcoming usability challenges associated with performing CPR on a patient.

This enables mechanical implementation of active compression/decompression which is currently implemented as a manual device. ACD has been shown to save lives. Mechanical implementation will reduce variability of therapy delivered further improving therapy and saving more lives.

With reference to FIG. 1, a mechanical chest compression system in accordance with an embodiment of the present disclosure is generally shown as a mechanical chest compression system 1000. The mechanical chest compression system 1000 may include a base 1100 and an actuation housing 1200 supported by a pair of opposing arms 1300 that may be detachably coupled to the base 1100. The base 1100 is configured to receive a patient “P” thereon such that the pair of opposing arms 1300 extends over a thorax of the patient “P” and the actuation housing 1200 is in a superposed relation with an anterior surface “AS” of the patient “P”. The actuation housing 1200 may include an actuation assembly 1210 that provides chest compression and decompression to the anterior surface “AS,” e.g., a sternum, of the patient “P”. To this end, the actuation assembly 1210 may include, e.g., an actuation arm 1212 having a contact portion 1212a that is configured to be detachably fixed to the anterior surface “AS” of the patient “P” to impart compressive and decompressive force on the anterior surface “AS” of patient “P”. The contact portion 1212a may include, e.g., a suction cup, adapted to contact the anterior surface “AS” of the patient “P”. In an embodiment, the contact portion 1212a may include adhesive to enhance securement of the contact portion 1212a to the anterior surface “AS” of the patient “P”. The actuation assembly 1210 further includes a lead screw 1220 operatively coupled to the actuation arm 1212. The actuation housing 1200 includes an actuator 1230 such as, e.g., a linear motor, that is operatively coupled to the lead screw 1220, whereby rotational output of the actuator 1230 is imparted to the lead screw 1220. The actuation housing 1200 further includes a force sensor 1240 configured to generate a force signal during compression and decompression of the anterior surface “AS” of the patient “P”. Alternatively, the force sensor 1240 may be disposed adjacent the contact portion 1212a, e.g., within the suction cup.

With continued reference to FIG. 1, a controller 1250 and a user interface module 1260 such as, e.g., a display, may be provided in the actuation housing 1200. The actuation arm 1212 is driven, either directly or indirectly, by the actuator 1230 under control of the controller 1250 to extend and retract the actuation arm 1212. The controller 1250 may include one or more processors. Cyclic extension and retraction of the actuation arm 1212 causes cyclic exertion of compressive and decompressive force to the anterior surface “AS” of the patient “P”. The controller 1250 actuates and controls operation of the actuation assembly 1210 and other elements or components of the mechanical chest compression system 1000. The controller 1250 may include one or more sets of instructions, procedures or algorithms to control actuation and operation of the actuator 1230 and other elements or components of the mechanical chest compression system 1000. The actuation arm 1212 may be further provided with, e.g., a coil spring, to facilitate retraction of the actuation arm 1212 during the decompression phases of the chest compression-decompression cycles. In some implementations, the user interface module 1260 is a combination of software and hardware and includes a display that presents information to a user of the mechanical chest compression system 1000. For example, the information presented may include textual information and graphical information such as graphs and charts. The user interface module 1260 may also include other components such as input devices, e.g., buttons, keys, etc. In some implementations, the user interface module 1260 may include audio input/output elements, e.g., a microphone, speaker, and audio processing software.

In some implementations, the user interface module 1260 may cause a user interface to appear on an external device, e.g., a device that is capable of operating independent of the mechanical chest compression system 1000. For example, the external device could be a smartphone, tablet computer, or another mobile device. The external device could also be a defibrillator such as the ZOLL Medical Corp X Series defibrillator (Chelmsford Mass.) with an accelerometer built into the defibrillation pads (e.g., CPR Stat-Padz), or other self-adhesive assembly containing a motion sensor that is adhered to the patient's sternum and measures primarily the motion of the patient's sternum.

In order to increase cardiopulmonary circulation induced by chest compression, a technique referred to as active compression-decompression (ACD) may be utilized. During the compression phase, the contact portion 1212a is pressed against the anterior surface “AS” of the patient “P” as with standard chest compressions. Unlike standard chest compressions where the chest passively returns to its neutral position during the release phase, with ACD, the contact portion 1212a actively pulls upward during release or decompression phase. This active pulling upward, or active decompression, increases the release velocity and results in increased negative intrathoracic pressure, as compared to standard chest compressions, and induces enhanced venous blood to flow into the heart and lungs from the peripheral venous vasculature of the patient. In particular, during ACD chest compression-decompression, the anterior surface “AS” of the patient “P” such as patient's sternum is typically pulled upward, i.e., away from the base 1100, beyond the neutral position of the sternum during the decompression phase, where “neutral” position is defined as the steady-state position of the sternum when no force—either upward or downward—is applied by the rescuer.

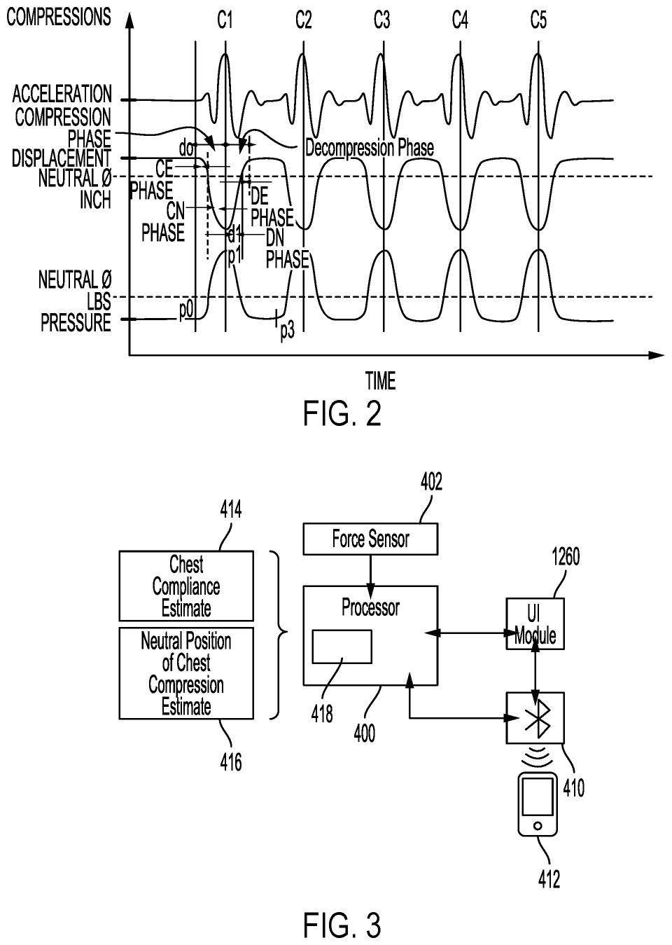

Both the compression phase and decompression phase will have a portion of their motion during which the sternum is pulled upward beyond the neutral position-what we term the “Elevated” phase. There are thus 4 phases: Compression: Elevated (CE); Compression: Non-elevated (CN); Decompression: Elevated (DE); Decompression: Non-elevated (DN) (FIG. 2).

In the case of non-ACI) CPR, during the time-course of a resuscitation, the patient's chest wall will “remodel” as a result of the repetitive forces applied to the chest wall—sometimes exceeding 100 lbs. of force needed to sufficiently displace the sternum for adequate blood flow—and the resultant repetitive motion. Chest compliance will typically increase significantly as the sternum/cartilage/rib biomechanical system is substantially flexed and stressed. Thus the amount of force needed to displace the sternum to the proper compression and decompression depths will also change significantly.

Each patient requires a unique amount of force to achieve the same compression of the sternum and the cardiopulmonary system due to the widely varying compliances of individual patients' chests. Chest compliance relationship is a measure of the ability of the chest to absorb an applied force and change shape in response to the force. Further, the chest compliance at a depth of, e.g., 0.5 inch, may be different from the chest compliance at a depth of, e.g., 1 inch. In the context of CPR, information about chest compliance can be used to determine how force can be applied to the chest of a patient in a way that will be effective at resuscitating the patient. For example, a chest compliance relationship may be utilized to determine the amount of force needed to achieve a target depth of compression. Ideally, a compression force creates positive pressure that results in blood flow from the heart to the peripheral tissue, and decompression creates negative pressure that enhances venous return of blood from the periphery back to the heart. However, if the force applied to the patient is not sufficient, CPR may not be effective which may reduce the survival rate of the patient. Further, if the force is not applied correctly or is excessive, the patient may suffer an injury.

For example, FIG. 1 illustrates the mechanical chest compression system 1000 performing active compression-decompression (ACD) CPR on a patient “P”. The user interface module 1260 may provide feedback to the user about. e.g., the parameters of the CPR. The feedback may be determined based in part on information about chest compliance of the patient “P” as measured or estimated by the mechanical chest compression system 1000. For example, the feedback may include the amount of force necessary to achieve the target depth based on the information about the chest compliance of the patient “P”. The feedback may also include the amount of actual force applied to the patient “P”. The user interface module 1260 may also notify the user of the occurrence of “remodeling” of the patient's chest, and thus, the need for calibration of the chest compliance relationship of the patient “P”.

Other feedback may include excessive compliance changes due to, e.g., rib fractures or detachment of the contact portion from the anterior surface of the patient. Such a feedback may provide visual alerts including. e.g., “potential fracture detected” or “contact portion may be misplaced.” Other drift in compliance and/or compliance waveform features may indicate that the contact portion may be slipping off the patient and that the device may need to be repositioned to the sternum. In addition, if too much chest remodeling occurs, the system may prompt for adjustment to the lift targets in order to reduce the gap between initial position (zero point) and current neutral position. Other feedback may include timing to next pause or prompts for rhythm analysis, ventilations, or shock.

In some implementations, the mechanical chest compression system 1000 may determine a chest compliance relationship that is then used to determine what feedback to provide the user. For example, the mechanical chest compression system 100 may calculate a mathematical relationship between two variables, such as displacement and force, related to chest compliance. The mechanical chest compression system 1000 can then identify one or more features of this relationship that can be used to determine information about the CPR treatment. Once the information about the CPR treatment is determined, the mechanical chest compression system 1000 can determine what feedback to provide to the user, e.g., feedback about the progress of the CPR treatment, feedback related to chest compression depth when in the non-elevated portion of the chest compression cycle or feedback related to the force when in the elevated portion of the chest compression cycle.

In some implementations, the chest compliance relationship can be thought of or represented as a curve, e.g., a curve of a graph representing the relationship. In some implementations, the chest compliance relationship can be stored as data such as a table of measured values (e.g., values for displacement and force at multiple time indices).

As shown in FIG. 1, the contact portion 1212a of the actuation arm 1212 keeps the mechanical chest compression system 1000 in contact with the anterior surface “AS” of the patient “P”. When the mechanical chest compression system 1000 applies decompression. i.e., a force in the direction of an arrow “D”, the anterior surface “AS” of the patient “P” is pulled upward in response due to, e.g., the suction of the suction cup or use of an adhesive pad on the contact portion 1212a against the anterior surface “AS” of the patient. This upward force creates a negative pressure within the thorax of the patient “P” during the release phase of a CPR treatment.

The neutral position of chest compression of the patient “P” serves as an inflection point that can be used to differentiate the movement of the chest on upward strokes from movement of the chest on downward strokes and generate specific measurements for the CE, CN, DN and DE phases of the compression cycle.

FIG. 1 illustrates the change in shape of the chest of the patient “P” as the mechanical chest compression system 1000 is used to perform ACD CPR. Because the chest of a patient “P” is not rigid, the chest will change shape in response to forces applied. When the sternum is compressed in the direction of the arrow “C” in the CN phase, the chest tends to exhibit a shape 30 (shown in phantom) that is compressed in the anterior-posterior dimension and extended in the lateral dimension. During the DE phase 210, the chest tends to exhibit a shape 40 (shown in phantom) that is extended in the anterior-posterior dimension and narrower in the lateral dimension. The chest exhibits a shape 20 corresponding to a neutral position of chest compression, when no force is applied either upwards or downwards. In other words, the shape 20 corresponds to the natural position of the chest when its shape is not substantially affected by a force applied, e.g., during CPR chest compressions.

Chest compliance is the mathematical description of this tendency to change shape as a result of an applied force. It is the inverse of stiffness. Chest compliance is the incremental change in depth (in the case of compression) or lift (in the case of decompression) divided by the incremental change in force at a particular instant in time. In the case of a chest compression cycle, the compliance may be plotted with time on the abscissa as shown in FIG. 2, or alternatively, the compliance may be plotted as a loop with depth as the independent variable and the time variable implied in the loop trajectory, as shown in FIGS. 3-5. If a patient's chest exhibits relatively little change in shape in response to a particular change of force, the patient has relatively low chest compliance. In contrast, if the patient's chest exhibits relatively high change in shape in response to a particular change of force, the patient has relatively high chest compliance. In addition, chest compliance varies as the chest is compressed as a result of the structural changes of the thoracic cavity due to positional/conformational changes as the chest is compressed downwards and pulled upwards.

In general, compliance, c, equals the change in displacement divided by the change in pressure (or force), compared to a reference time point:

$$c = Δ d / Δ p \qquad Eq . 1$$

In some implementations, the mechanical chest compression system 1000 may include both the force sensor 1240, e.g., load cells, pressure sensor, strain gauges, force sensing resistors, ultrasonic force sensors, optical force sensors, etc. (FIG. 1). Alternatively, the mechanical chest compression system 1000 may further utilize an accelerometer. The accelerometer senses the motion of the chest during CPR and the force sensor measures the force or pressure applied. The accelerometer signal may be integrated (e.g., doubly integrated) to determine the displacement of the actuation housing 1200, and the output of the force sensor is converted to standard pressure or force units. While the chest compliance is utilized herein, it is contemplated that stiffness may be used.

FIG. 2 represents signals recorded during CPR, e.g., using the force sensor 1240 and an accelerometer. Compressions (C1-C5) can be detected from the displacement signal. The compression rate is calculated from the interval between compressions (e.g. (time of C2-time of C1)), and compression depth is measured from the compression onset to peak displacement (e.g. (d1-d0)). The onset and peak compression values are saved for each compression. The pressures at the compression onset and offset are used to determine the force used to achieve a given compression depth, as will be described hereinbelow.

FIG. 3 is a block diagram of components of the mechanical chest compression system 1000 shown in FIG. 1. The mechanical chest compression system 1000 includes the controller 1250 having, an electronic component such as, e.g., a processor 400, that carries out instructions, e.g., processes input data to generate output data, and communicates data to and from other components of the mechanical chest compression system 1000. For example, the controller 1250 receives signals from the force sensor 1240. The processor 400 also communicates output information to a user interface module 1260. The output information 406 may include parameters of CPR as described above. The output information 406 may be determined by the processor 400 in part based on signals received from the sensors, e.g., the force sensor 1240, or the chest compliance relationship.

In some implementations, the external device 412 communicates with the mechanical chest compression system 1000 using, e.g., a wireless communication technique such as Bluetooth. In this example, the mechanical chest compression system 1000 has a wireless communication module 410. For example, the user interface module 1260 may communicate signals to and from the external device 412 using the wireless communication module 410. Although Bluetooth is used as an example here, other wireless communications techniques could be used, such as Wi-Fi, Zigbee, 802.11, etc. In some implementations, the external device 412 may serve as a secondary user interface that may provide the output information 406. In addition, the external device 412 may communicate with the processor 400 through wired or wireless communication techniques.

In some implementations, a processor 400 can perform calculations to determine an estimate of chest compliance 414, e.g., using the equations described herein-above. The processor 400 can further calculate an estimated neutral position of chest compression 416. e.g., based on data such as the estimated depth of chest compression and the estimate of chest compliance 414. The calculation can be based in part on a feature of a compliance relationship as described below in further detail with respect to FIGS. 3-5.

During ACD chest compression, the patient's sternum is typically pulled upward beyond the neutral position of the sternum during the decompression phase, where “neutral” is defined as the steady-state position of the sternum when no force (either upward or downward) is applied. The neutral position may also be considered the position at which zero force or pressure is exerted during ACD compressions. Because of so-called chest remodeling that occurs during chest compressions, this zero-force neutral position may change over the course of resuscitation efforts, as the anterior/posterior diameter of the patient decreases after multiple compression cycles. Alternatively, the neutral position location may be the initial position of the sternum prior to initiation of chest compressions. The neutral position of chest compression of the patient “P” serves as an inflection point that can be used to differentiate the movement of the chest on upward strokes from movement of the chest on downward strokes and generate specific measurements for the CE, CN, DN and DE phases of the compression cycle.

In some implementations, the processor 400 includes or has access to a memory 418 that can store data. The memory 418 can take any of several forms and may be integrated with the processor 400 (e.g., may be part of the same integrated circuit) or may be a separate component in communication with the processor 400 or may be a combination of both. In some implementations, the memory 418 stores data such as values for the estimate of chest compliance 414. In some implementations, the processor 400 uses the memory 418 to store data for later retrieval, e.g., stores data during an administration of CPR for retrieval later during the same administration of CPR or for retrieval later during a different administration of CPR.

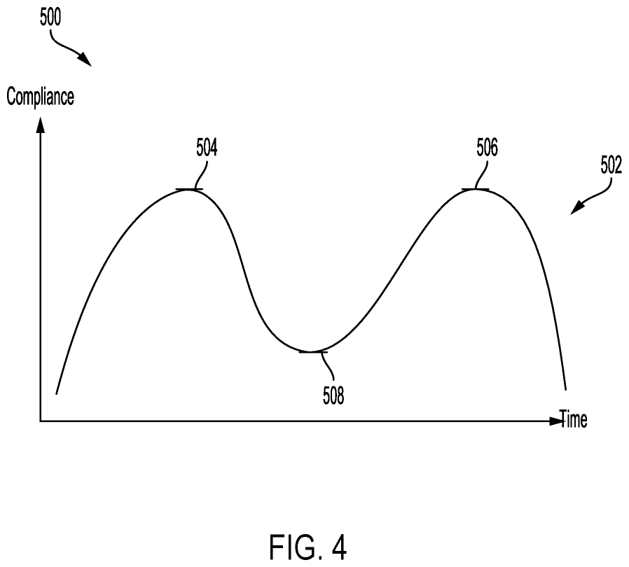

FIG. 4 shows an example graph 500 including a chest compliance curve 502. In some implementations, the compliance curve 502 is a representation of data calculated by the processor 400 (FIG. 3) based on input received from sensors, e.g., a force sensor and/or accelerometer(s). The graph 500 shown in FIG. 4 includes an x-axis representing time (e.g., in seconds) and a y-axis representing chest compliance. The curve 502 exhibits a sinusoidal shape.

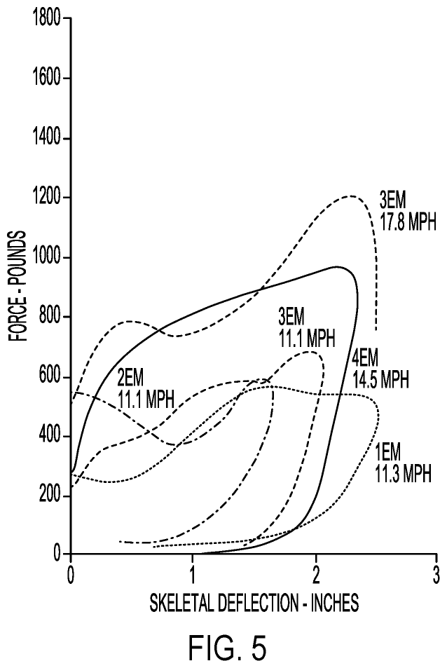

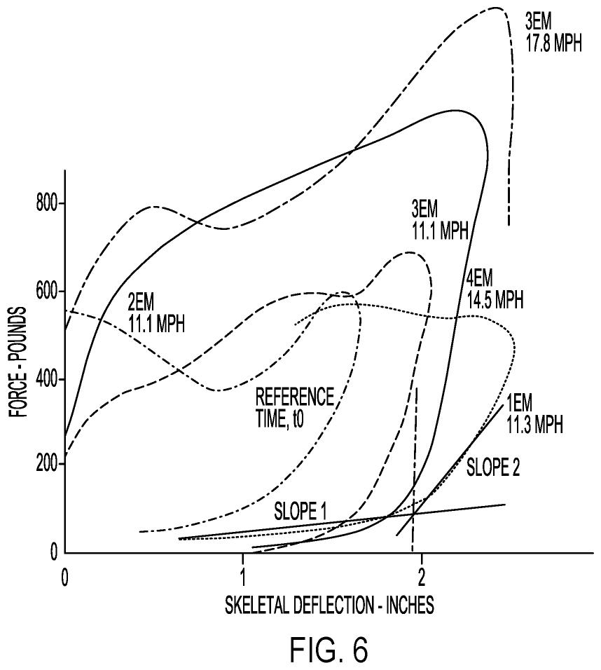

FIG. 5 shows representative stiffness curves for sternal impact, and FIG. 6 shows stiffness regions of the curves. Referring to these figures, the slopes of the representative curves are the stiffness (e.g., the inverse of compliance). Each of the loops is the curve for a different subject. Slope 1 in FIG. 6 is the stiffness for the CN phase of the compression: it is a lower slope value and less stiff (and thus higher compliance). Though the slopes for the CN phase of compression for each subject varies as seen in the multiple loops in the figure, in most if not all cases, there will be a change in slope to a second, steeper slope (lower compliance, and stiffer) at some inflection point during the compression, represented by the shift to Slope 2.

At the inflection point represented by the intersection of the two lines, Slope 1 and Slope 2 in the figure, the risk of fracturing is still relatively low. Once the inflection point has been detected, the system can prompt the rescuer to maintain that compression depth, as it is still in the safe range. This patient-specific compression depth will likely be different than AHA/ILCOR Guidelines (e.g. more than 2 inches (about 51 mm)). For instance, initially at the start of the resuscitation efforts, the patient's chest may be much stiffer, particularly for elderly patients, where their sternal cartilage attaching the sternum to the ribs has calcified and stiffened. If the rescuer were to try and deliver compressions at a depth recommended by the AHA/ILCOR Guidelines, they would likely cause rib fractures in the patient. In fact, in the Guidelines statement themselves, it is acknowledged that rib fractures are a common occurrence using existing chest compression methods. “Rib fractures and other injuries are common but acceptable consequences of CPR given the alternative of death from cardiac arrest.” (From the 2005 International Consensus Conference on Cardiopulmonary Resuscitation and Emergency Cardiovascular Care Science with Treatment Recommendations, hosted by the American Heart Association in Dallas. Tex., Jan. 23-30, 2005.) Aside from the discomfort of the nosocomial rib fractures, an unfortunate side effect of the rib fractures is that they result in reduced resilience of the chest wall and thus a reduction in the natural recoil of the chest during the decompression phase resulting in a reduced venous return and degraded chest compression efficacy. It is desirable to minimize or eliminate rib fractures for these reasons. By detecting changes in the chest wall compliance, and prompting the rescuer as a result of those detections, chest compression depth will not exceed the injury threshold of ribs and sternum.

Because the overall compliance of the chest varies over the course of the resuscitation effort, the depth to which the rescuer is being guided by the real-time prompting of the system will also vary using this approach. A phenomena known as chest-wall remodeling occurs during the initial minutes subsequent to the initiation of chest compressions. Anterior-posterior diameter may decrease by as much as 0.5-1 inch, and compliance of the chest wall will increase as the sternal cartilage is gradually softened. By staying within the safety limits in a customized fashion for each individual patient for each compression cycle as the chest gradually softens, injuries are reduced, but more importantly, the natural resilience of the chest wall is maintained and more efficacious chest compressions are delivered to the patient.

In contrast, when the patient's chest is at a neutral position of chest compression (generally corresponding to the natural resting position of the chest), chest compliance tends to be at its highest point. Thus, in the curve 502 shown in FIG. 4, the points 504, 506 corresponding to the highest chest compliance (e.g., the peaks of the sinusoid) tend to correspond to the neutral position of chest compression. In contrast, the points 508 correspond to the lowest chest compliance (e.g., the troughs of the sinusoid) tend to correspond to the limits of the chest's compression shape or decompression shape.

Systems and methods will now be described in which measures of force applied to the chest and displacement of the chest when the patient is undergoing active compression decompression treatment are used to establish one or more force-displacement relationships from which multiple depths of compression corresponding the force-displacement relationship(s). The force-displacement relationship(s) may be based on the estimated instantaneous compliance of the chest, as discussed above.

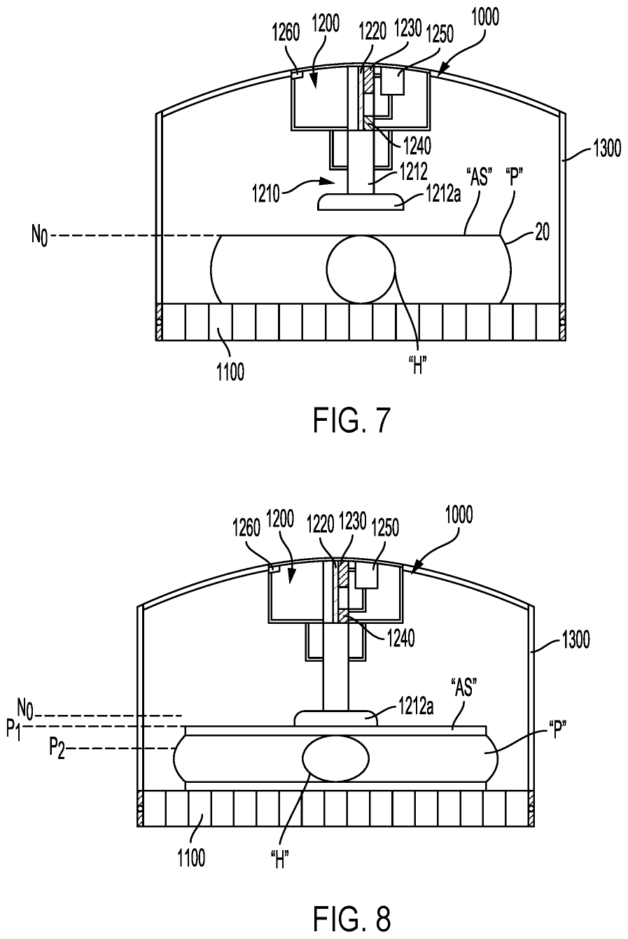

In use, with reference to FIG. 7, the patient “P” is placed on the base 1100 and the pair of opposing arms 1300 is detachably coupled to the base 1100 such that the actuation housing 1200 that is supported by the pair of opposing arms 1300 is disposed in a superposed relation with the anterior surface “AS” of the patient “P”. The user may adjust the contact portion 1212a of the actuation assembly 1210 to affix the contact portion 1212a to the anterior surface “AS” of the patient “P”. At this time, the anterior surface “AS” of the patient “P” defines the neutral position No. In order to provide adequate amount of compression and decompression to the patient “P”, while minimizing risk of injury or trauma to the patient “P”, the processor of the controller 1250 determines the compliance relationship based on Eq. 1 described hereinabove. The compliance relationship may then be utilized to determine the amount of force necessary to achieve the target compression, as will be described hereinbelow.

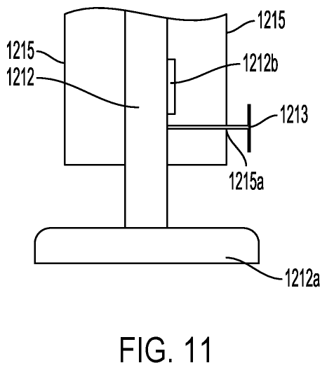

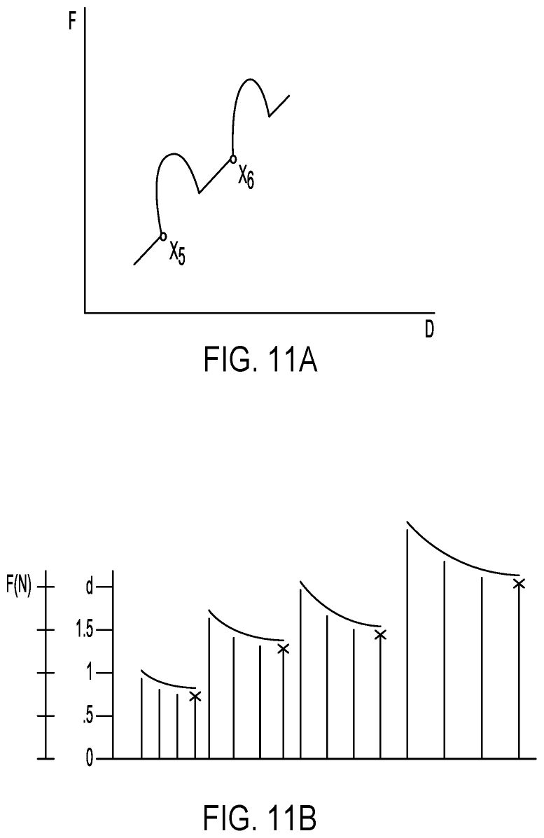

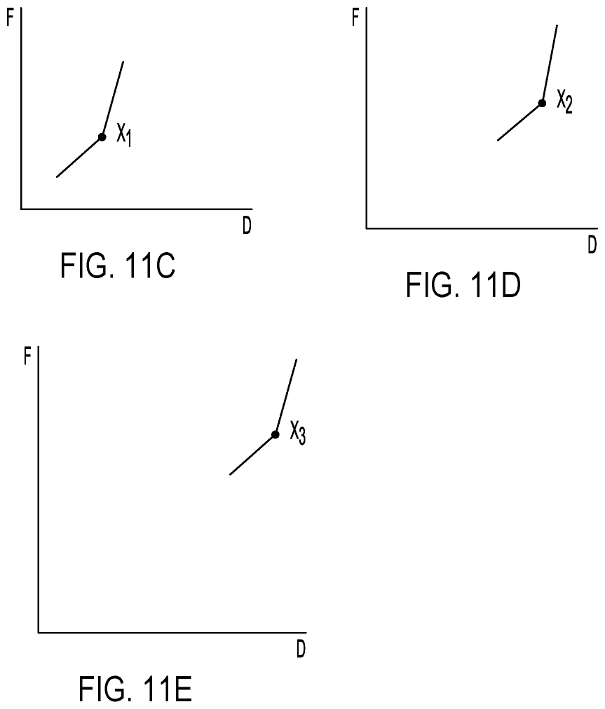

The compliance relationship may be determined using various methods. First, the compliance c may be determined by measuring a force applied to the anterior surface “AS” of the patient “P” at a preset location P₁ by the force sensor 1240, as shown in FIG. 8. Specifically. Eq. 1 may be utilized, wherein the change in displacement equals to P₁−N₀ and the change in pressure equals to the force measured at P₁. Prior to initiating a compression cycle, compliance determination may be carried out several times and, e.g., an average value thereof, may be used as compliance c. As shown in FIG. 11B, compliance determination at each preset position may be carried out several times to minimize the range of values such that the latest compliance value approaches the average value. In addition, compliance relationship may be calculated at various preset locations, e.g., at P₁, P₂ . . . Pₙ, in order to obtain the most accurate compliance value. For example, compliance c may be determined at preset locations including 0.5 in, 1.0 in, or 1.5 in away from N₀. It is contemplated that other preset locations may be utilized. As described hereinabove, chest compliance will typically increase significantly during the course of treatment as the sternum/cartilage/rib biomechanical system is substantially flexed and stressed. Thus the amount of force needed to displace the sternum to the proper compression and decompression depths will also change significantly. Accordingly, compliance c may be periodically re-calculated during the treatment. For example, 1-10 second calibration period may follow each or every other CPR intervals. For example, each CPR interval may be about 2 minutes. Periodic reconfirmation of calibration may also be achieved by driving the contact portion 1212a to a preset location and comparing the measured compliance to that of the curve developed during calibration, effectively requiring a single compression (see, e.g., FIG. 11B). For more robust reconfirmation, this may be done by alternating the preset locations and/or the number of compressions to minimize therapy interruptions.

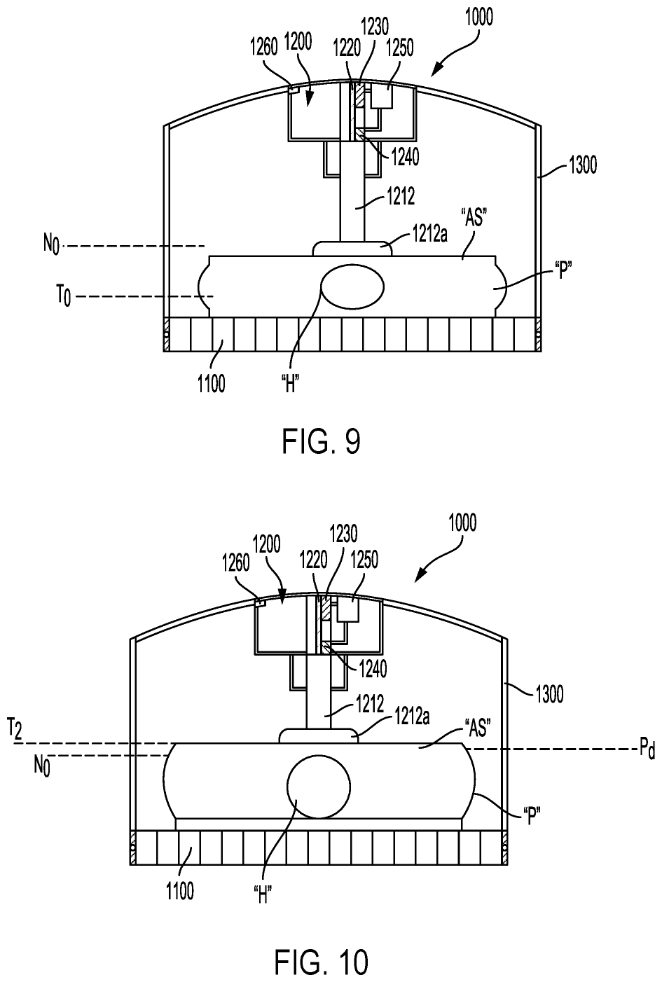

After determining compliance c, the processor may determine the compression force needed for the contact portion 1212a to reach the target position T₀ (FIG. 9), as shown by Eq. 2 hereinbelow.

$$Δ p = Δ d / c \qquad Eq . 2$$

wherein Δd is the change in displacement, which equals to T₀−N₀ and c is the compliance obtained at least one of the preset locations P₁, P₂ . . . Pₙ

After determining the amount of force needed to achieve compression to the target location T₀ (FIG. 9), the processor generates instructions to drive the contact portion 1212a to provide compression to the anterior surface “AS” of the patient “P”. In some implementations, additional target locations having a larger displacement may be chosen during the treatment.

Similarly, compliance for the decompression phase may be obtained in a manner shown above with respect to the compression phase. For example, compliance c may be determined by measuring a force applied to the anterior surface “AS” of the patient “P” at a preset location P_{d} (FIG. 10) by the force sensor 1240. Specifically, Eq. 1 may be utilized, wherein the change in displacement equals to N₀−P_{d} and the change in pressure equals to the force measured at P_{d}. After determining compliance c for decompression phase, the processor may determine the decompression force needed for the contact portion 1212a to reach the target location T₂ (FIG. 10), by using Eq. 2, wherein Δd is the change in displacement, which equals to N₀−T₂ and c is the compliance obtained at the preset location P_{d}. It is also envisioned that multiple points may be utilized to account for a non-linear relationship between force and lift.

Alternatively, compliance c of Eq. 1 and Eq. 2 may be obtained via a table having empirical chest compliance relationship data or the graphs shown in FIGS. 2 and 4-6. Compliance c obtained in this manner in conjunction with the change in displacement (Δd), i.e., T₀−N₀, provides the amount of force necessary for the contact portion 1212a of the actuation arm 1212 to reach the target position T₀.

With reference to FIG. 11, axial translation of the actuation arm 1212, i.e., the change in displacement (Δd), may be limited to a particular preset position P₁, P₂ . . . Pₙ. The actuation arm 1212 is slidably extendable through an outer sleeve 1215 disposed about the actuation arm 1212. The actuation arm 1212 may include a stop 1212b and the outer sleeve 1215 may include a corresponding peg 1213 that is removably received through a bore 1215a defined in a lateral side of the outer sleeve 1215. Under such a configuration, the peg 1213 that is received through the bore 1215a of the outer sleeve 1215 inhibits axial translation of the actuation arm 1212 when the stop 1212b of the actuation arm 1212 comes in contact with the peg 1213. The placement of the stop 1212b of the actuation arm 1212 and the bore 1215a of the outer sleeve 1215 may be chosen to provide a desired preset position of the contact portion 1212a. In this manner, the force measured by the force sensor 1240 just before the stop 1212b engages the peg 1213 may correlate to a force at the desired preset position (FIG. 10), as there will be a spike in force reading when the stop 1212b comes in contact with the peg 1213. FIGS. 11C-11E illustrate the force reading that spikes when the stop 1212b engages the peg 1213 at respective preset positions X₄, X₅, X₆. While only three preset positions X₄, X₅, X₆, are shown, it is further contemplated that additional preset positions may be utilized to improve accuracy of the compliance relationship.

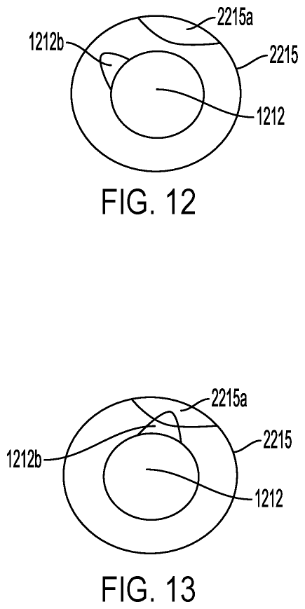

In some implementations, the actuation arm 1212 may be rotatably disposed about an outer sleeve 2215 (FIG. 12). The outer sleeve 2215 may include a stop 2215a configured to engage the stop 1212b of the actuation arm 1212. Under such a configuration, the stops 1212b, 2215a may be transitionable between an engaged position, (FIG. 13), in which, the stop 2215a of the outer sleeve 2215 engages the stop 1212b of the actuation arm 1212 and inhibits axial translation of the actuation arm 1212, and a disengaged position (FIG. 12), in which, the stop 1212b of the actuation arm 1212 is angularly offset from the stop 2215a to enable axial translation of the actuation arm 1212. In some implementations, the outer sleeve 2215 may be rotatable about the actuation arm 1212. In some implementations, the outer sleeve 2215 may include a plurality of stops 2215a along a length thereof. In some implementations, each stop of the plurality of stops 2215a may be is selectively adjustable along a length of the outer sleeve 2215.

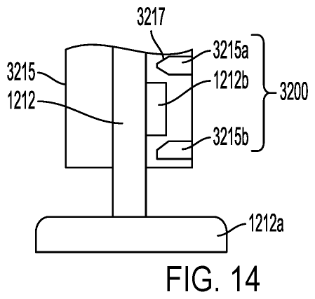

With reference to FIG. 14, in some implementations, an outer sleeve 3215 and the actuation arm 1212 have a detent mechanism 3200. Specifically, the detent mechanism 3200 includes the stop 1212b on the actuation arm 1212 and inner protrusions 3215a, 3215b that extend radially inwardly from an inner surface of the outer sleeve 3215. When the stop 1212b of the actuation arm 1212 engages an inner protrusion 3215a, 3215b, such a contact impedes axial translation of the actuation arm 1212 in order to enable the force sensor to measure force just before the preset position, as there will be a spike in force reading when the stop 1212b comes in contact with an inner protrusion 3215a, 3215b. However, the stop 1212b of the actuation arm 1212 or the inner protrusions 3215a, 3215b may be formed of a flexible or compressible material such that the detent mechanism 3200 enables axial translation of the actuation arm 1212 with sufficient force to overcome the detent mechanism 3200. Under such a configuration, force measurements at various preset positions may be taken without making adjustments to the detent mechanism 3200. Alternatively, the force associated with clearing an inner protrusion 3215a, 3215b may be predetermined such that the compliance relationship may be determined between inner protrusions 3215a, 3215b. In addition, the inner protrusions 3215a, 3215b and/or the stop 1212b may include different shapes to require different force spikes for clearing, to thereby allow for calibration of the force measurement and compliance estimates.

In some implementations, the inner protrusions 3215a, 3215b may include chamfered portions 3217 to further facilitate axial translation of the stop 1212b of the actuation arm 1212 through the inner protrusions 3215a, 3215b. It is contemplated that the outer sleeves and the actuation arms described hereinabove may include a safety stop to limit maximum compression or decompression of the anterior surface “AS” of the patient “P”. For example, the maximum compression may be set to about 4 inches (about 102 mm), and the maximum lift above the neutral point may be set to about 1 inch. FIG. 11A illustrates the force reading that spikes when the stop 1212b engages the inner protrusions 3215a, 3215b at respective preset positions X₅, X₆ along the axial travel of the actuation arm 1212. While only two preset positions X₅, X₆ are shown, it is further contemplated that additional preset positions may be utilized to improve accuracy of the compliance relationship.

Safety stops may be set as maximum force exerted on the anterior surface of the patient, maximum lift distance predefined as a hard mechanical stop, and/or minimum compliance allowable at compression peak/trough. Another safety stop could be set based on changes in force or compliance, in order to inhibit sudden changes in force that could be the cause or result of an injury. In some implementations, a safety mechanism may include a pressure valve on the suction cup that releases the vacuum at a specific maximum pressure, thus detaching the chest from the cup. This may be done also with barometers inside the cup chamber.

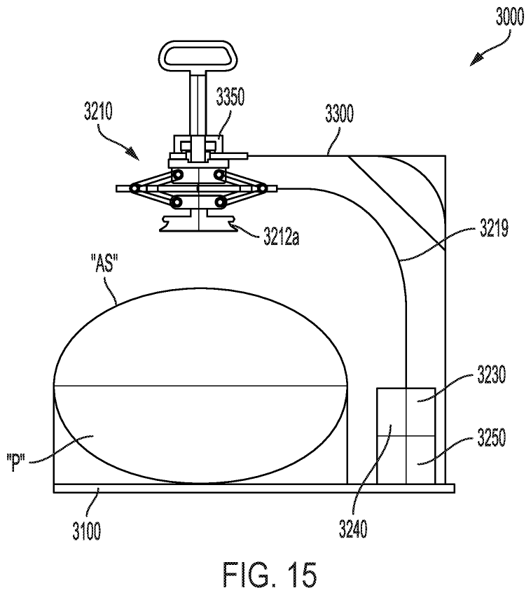

FIG. 15 shows another implementation of the mechanical chest compression system. In contrast to the mechanical chest compression system 1000 (FIG. 1), in which, compression/decompression is carried out by the actuation arm 1212, a mechanical chest compression system 3000 includes an actuation assembly 3210 that utilizes a linkage assembly having, e.g., a scissor jack configuration, which has mechanical advantage, which, in turn, reduces a height requirement of the mechanical chest compression system 3000 by reducing the amount of axial travel of the contact portion 3212a. Further, such a configuration provides improved stability and portability of the mechanical chest compression system 3000. In addition, the mechanical chest compression system 3000 also improves stability of operation by placing the actuator 3230 on a base 3100, rather than above a patient, as will be described hereinbelow. In some implementations, the linkage assembly may include a cover or a sleeve to protect the clinician from injury during actuation of the linkage assembly.

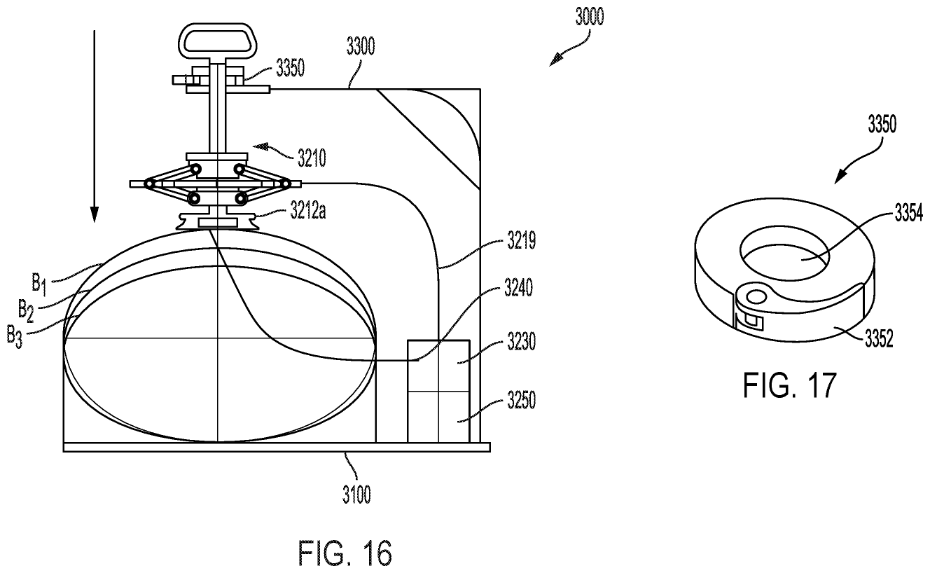

With reference to FIGS. 16 and 17, the mechanical chest compression system 3000 includes a base 3100 configured to receive the patient “P” thereon and a support arm 3300 that is detachably coupled to the base 3100. The support arm 3300 supports the actuation assembly 3210 in a superposed relation with an anterior surface “AS” of the patient “P”. In particular, the support arm 3300 includes a release clamp 3350 configured to adjustably couple the actuation assembly 3210 thereto. A lever 3352 of the release clamp 3350 may be pivoted to enlarge or reduce a size of a bore 3354 of the release clamp 3350. Under such a configuration, the actuation assembly 3210 may be adjustable positioned to different body types B₁, B₂, B₃.

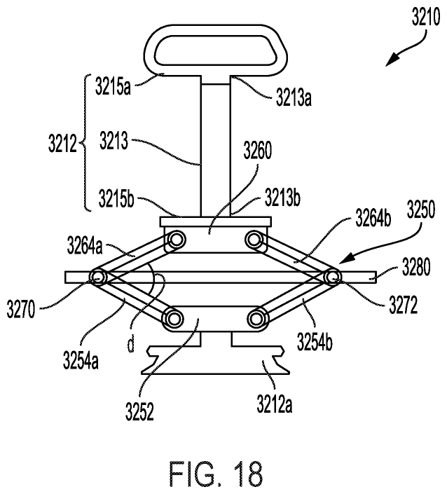

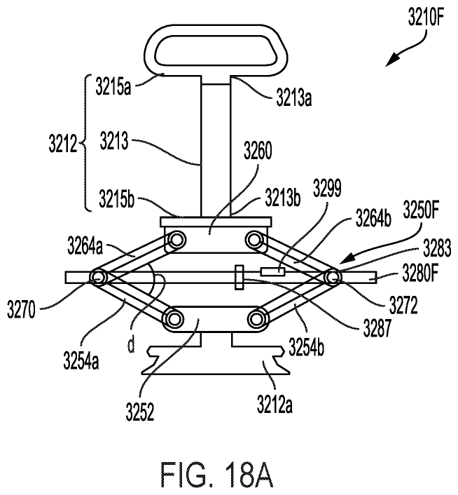

With reference to FIG. 18, the actuation assembly 3210 includes an adjustment bar 3212 having an elongate portion 3213 and first and second stops 3215a, 3215b. The elongate portion 3213 is dimensioned to be received through the bore 3354 (FIG. 17) of the release clamp 3350. The first and second stops 3215a, 3215b are placed at respective first and second ends 3213a, 3213b of the elongate portion 3213 to axially limit and retain the release clamp 3350 on the elongate portion 3213. The linkage assembly 3250 includes a base portion 3252 including a plurality of actuation arms having first arms 3254a, 3254b that are spaced apart and pivotably coupled to the base portion 3252. The base portion 3252 is coupled to a contact portion 3212a such as, e.g., a suction cup, to enable movement as a single construct. The linkage assembly 3250 further includes a connecting part 3260 that is coupled to the elongate portion 3213 of the adjustment bar 3212. The connecting part 3260 includes additional actuation arms having second arms 3264a, 3264b that are spaced apart and pivotably coupled to the connecting part 3260. The first arm 3254a and the second arm 3264a are pivotably connected about a first pivot 3270, and the first arm 3254b and the second arm 3264b are pivotably connected at a second pivot 3272. The first and second pivots 3270, 3272 are spaced apart.

The linkage assembly 3250 further includes a lead screw 3280 that is threadably coupled to the first arms 3254a, 3254b and second arms 3264a, 3264b. In particular, the lead screw 3280 may transversely extend through the first and second pivots 3270, 3272. Rotation of the lead screw 3280 in a first direction moves the first and second pivots 3270, 3272 towards each other, which, in turn, moves the base portion 3252 and the connecting part 3260 away from each other, and rotation of the lead screw 3280 in a second direction moves the first and second pivots 3270, 3272 away from each other, which, in turn, moves the base portion 3252 and the connecting part 3260 towards each other. In this manner, depending on the direction of the rotation of the lead screw 3280, the contact portion 3212a that is coupled to the base portion 3252 applies compression or decompression to the anterior surface “AS” of the patient “P”. The first arms 3254a, 3254b may define, e.g., an acute, angle with respective second arms 3264a, 3264b. For example, the acute angle α may range between about 25 degrees and about 66.5 degrees.

In some implementations, a linkage assembly 3250F (FIG. 18A) may include a detent mechanism. Specifically, the detent mechanism may include a stop 3299 on the lead screw 3280F and inner protrusions 3283 (only one shown) that extend inwardly from an inner surface of the first arms 3254a, 3254b or the second arms 3264a, 3264b. When the stop 3299 of the lead screw 3280F engages an inner protrusion 3283 such a contact impedes axial translation of the lead screw 3280F in order to enable the force sensor to measure force just before the spike in force reading that occurs when the stop 3299 comes in contact with the inner protrusion 3283. However, the stop 3299 of the lead screw 3280F or the inner protrusions may be formed of a flexible or compressible material such that the detent mechanism enables axial translation of the lead screw 3280F with sufficient force. Under such a configuration, force measurements at various preset positions may be taken without making adjustments to the detent mechanism 3200. In some implementations, the stop 3299 or the inner protrusions 3283 may include chamfered portions to further facilitate axial translation of the lead screw 3280F. It is contemplated that the detent mechanism may further include a safety stop to limit maximum compression or decompression of the anterior surface “AS” of the patient “P”. In some implementations, a plurality of stops 3299 on the lead screw 3280F and a plurality of inner protrusions 3283 may be utilized in a manner described hereinabove to determine compliance relationship. In some implementations, the linkage assembly 3250F may include a safety stop 3287 that limits the maximum axial travel of the contact portion 3212a. The safety stop 3287 may be disposed on the lead screw 3280F similar to the stop 3299.

With reference back to FIG. 16, a flexible drive shaft 3219 operatively connects the actuator 3230 to the lead screw 3280. Such a configuration enables placement of the actuator 3230 on the base 3100. For example, a controller 3250 may be provided adjacent the actuator 3230 on the base 3100. Such a configuration reduces the number of components supported by the support arm 3300, which, in turn, lowers the center of mass of the mechanical chest compression system 3000. Such a configuration may improve stability, as well as operability of the mechanical chest compression system 3000. The force sensor 3240 may be disposed within or adjacent the contact portion 3212a.

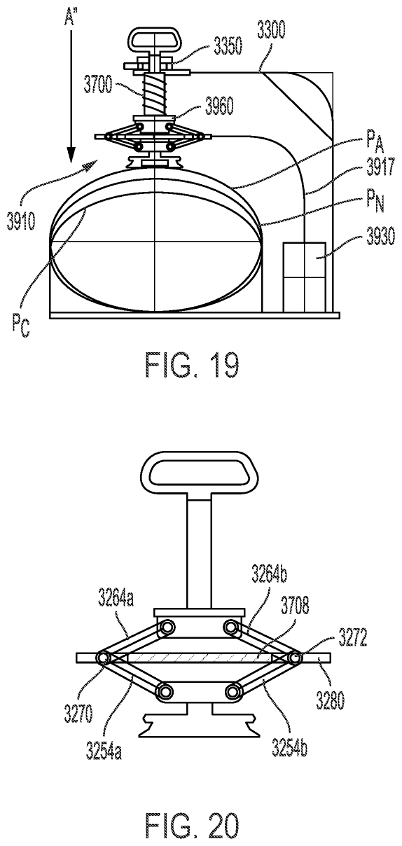

The compression and decompression cycle has an asymmetric load requirement. For example, compression may require 70 N compression force and decompression may only require 10 N decompression force. Rather than underutilizing an actuator that is capable of providing 70 N compression force, the actuation assembly 3910 may be preloaded with a spring 3700, as shown in FIG. 19, and be able to use an actuator 3930 having a lower load capacity. In addition, the preloaded actuation assembly 3910 may be calibrated to its zero force loading and, thus, eliminating the need for complex sensors that measure force in both directions. If the spring 3700 provides a preloaded force of, e.g., 30 N, then the actuator 3930 only needs to be capable of providing compression and decompression force of 40 N to meet the above-identified asymmetric load requirement. Such a configuration would eliminate underutilization of a high capacity actuator. In an implementation, the spring 3700 may be interposed between the release clamp 3350 and a connecting part 3960 of the actuation assembly 3910. In another implementation, the spring 3708 may be interposed between the first pivot 3270 about which the first arm 3254a and the second arm 3264a are pivotably connected, and the second pivot 3272 about which the first arm 3254b and the second arm 3264b are pivotably connected, as shown in FIG. 20. With reference back to FIG. 19, the actuation assembly 10 may be transitionable between a compression position P_{c}, a neutral position Pₙ, and an active decompression position Pₐ.

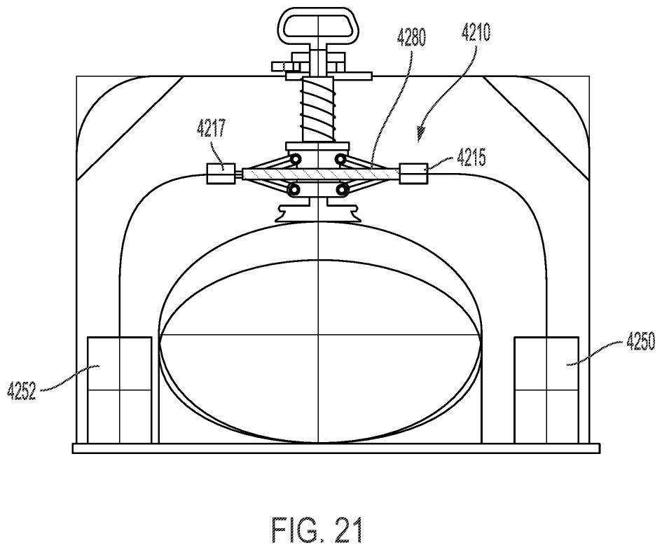

In some implementations, the mechanical chest compression system 4000 may include a dual actuator configuration, as shown in FIG. 21. Each actuator 4250, 4252 is dedicated to performing either compression or decompression. Under such a configuration, each actuator 4250, 4252 may be tailored to meet the corresponding compression or decompression load requirement. For example, one actuator 4250 may be suited for, e.g., 70 N, compression and the other actuator 4252 may be suited for 10 N decompression. A dual actuator assembly 4210 requires respective ratchet/clutch assemblies 4215, 4217 that control engagement of a lead screw 4280 with first actuator 4250 or the actuator 4252 based on the required compression or decompression phase of the treatment.

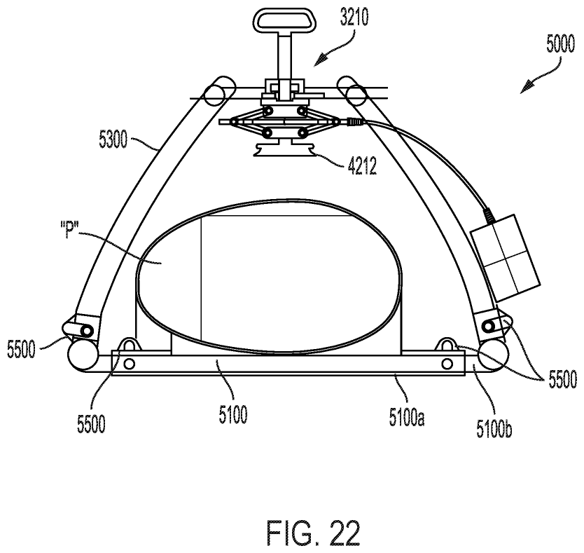

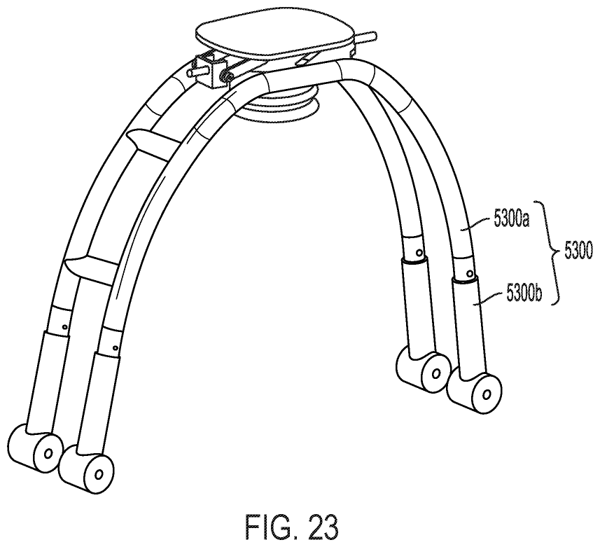

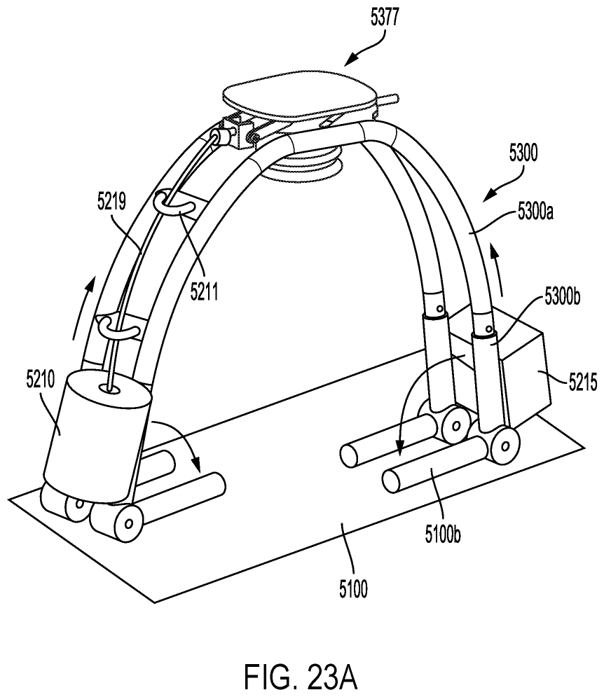

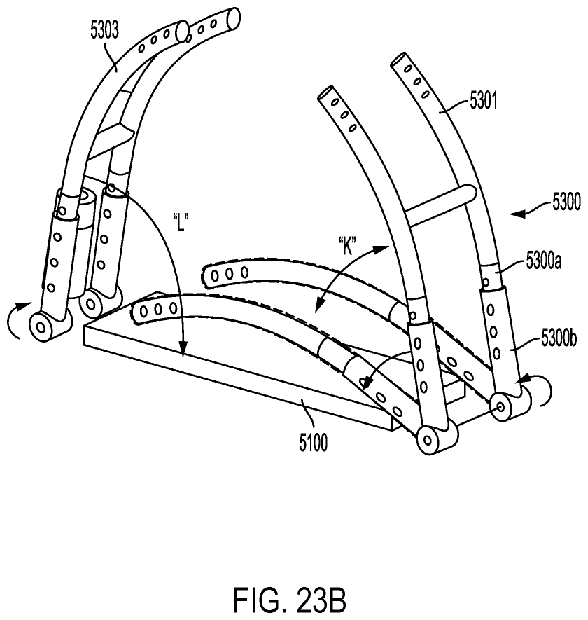

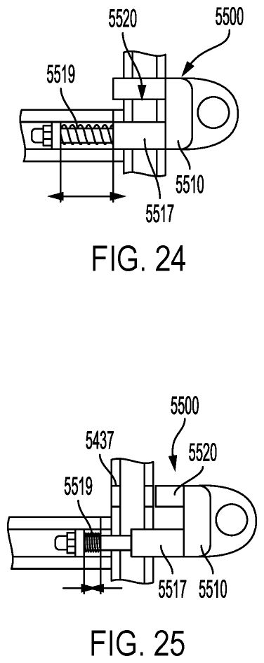

In some implementations, a mechanical chest compression system 5000 includes a base 5100 configured to support the patient “P” thereon and a support frame 5300 configured to support the actuation assembly 3210. The base 5100 and the support frame 5300 each include telescopic portions 5100a (FIG. 22), 5100b (FIG. 22). 5300a (FIG. 23), 5300b (FIG. 23) such that the length of the base 5100 and the height of the support fame 5300 may be adjustable, which, in turn, enables the mechanical chest compression system 5000 to be tailored to the patient “P” for improved positioning of the contact portion 4212a. The base 5100 and the support frame 5300 include locks 5500 that are disposed adjacent opposite ends of the base 5100, as shown in FIGS. 24 and 25. The locks 5500 are utilized to maintain the desired length of the base 5100 and the desired height of the support frame 5300. In particular, the base 5100 and the support frame 5300 define a plurality of bores 5437 (FIG. 25). Each lock 5500 includes a body 5510, an anchor 5517 pivotably secured to the base 5100 or the support frame 5300, and a locking Finger 5520 that is dimensioned to be releasably received in the bores 5437. The anchor 5517 is biased towards the corresponding base 5100 or the support frame 5300 by a spring 5519. Each finger 5520 is pivotable and movable between a locked position, in which, the finger 5520 is received in a bore 5437, and a released position, in which, the finger 5520 is released from the bore 5437.

With reference to FIG. 23B, the support frame 5300 may be collapsible for non-use or storage. In particular, the telescopic portions 5100b (shown in FIG. 23A and not shown in FIG. 23B) may be hingedly coupled to the respective telescopic portions 5300b to enable rotation of the support frame 5300 in the directions of arrows “K” and “L” after a compression device 5377 (FIG. 23A) has been detached from the support frame 5300 or detached from one side of the support frame 5300. FIG. 23B illustrates a first side 5301 of the support frame 5300 rotated towards the base 5100, shown in phantom. Similarly, a second side 5303 of the support frame 5300 may be rotated towards the base 5100 in the direction of the arrow “L” to reduce the size of the mechanical chest compression system 5000.

In some implementations, an actuator 5210 and a battery 5215 may be coupled to the support frame 5300. In some implementations, the support frame 5300 may include cable management loops 5211 to manage and guide a flexible drive shaft 5219 therethrough.

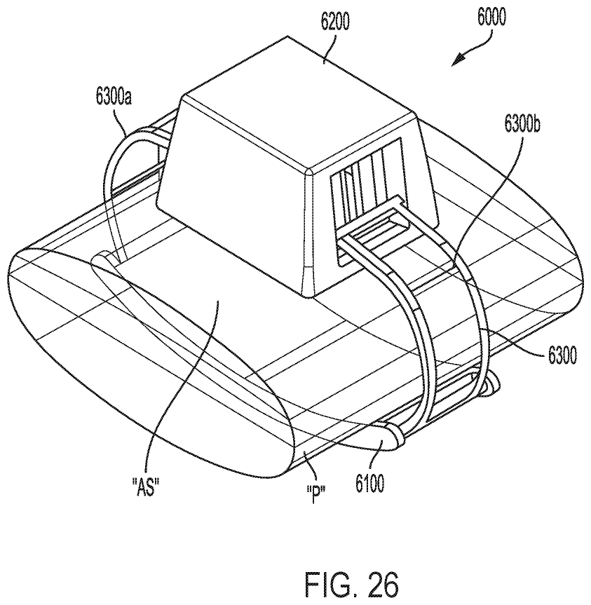

With reference now to FIG. 26, one implementation of a mechanical chest compression system is shown generally as a mechanical chest compression system 6000. In contrast to the mechanical chest compression systems described hereinabove, the mechanical chest compression system 6000 includes an actuation housing 6200 that is adjustable relative to a support frame 6300 based on the size of the patient “P”, as will be described hereinbelow. Under such a configuration, the center of gravity of the mechanical chest compression system 6M) is moved to better align with the size of the patient. In this manner, the shifting of the contact portion on the anterior surface of the patient during, e.g., transport, is reduced.

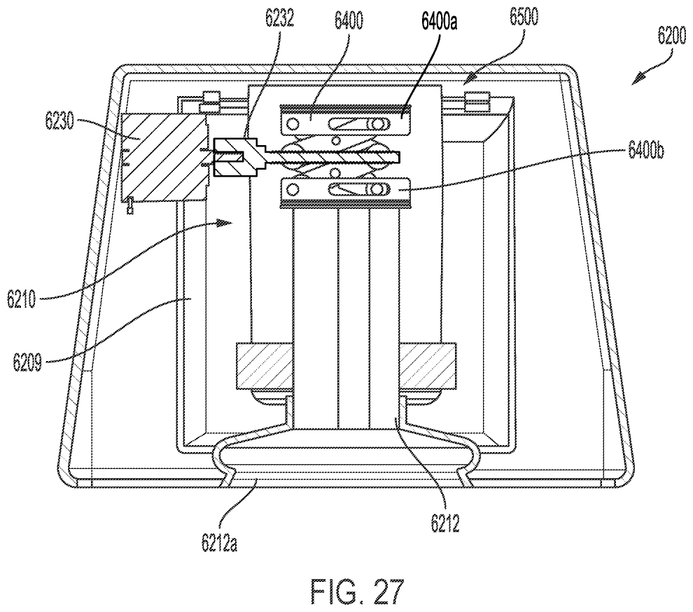

The mechanical chest compression system 6000 includes a base 6100 configured to receive a patient “P” thereon, an actuation housing 6200 having an actuation assembly 6210 (FIG. 27) configured to provide compression and decompression on the anterior surface “AS” of the patient “P”, and a support frame 6300 having first and second portions 6300a, 6300b.

With reference to FIG. 27, the actuator housing 6200 includes the actuation assembly 6210 and an adjustment assembly 6500. The actuation assembly 6210 includes an actuator 6230 such as, e.g., a stepper motor or a DC motor, a mechanical linear actuator 6232 such as, e.g., a ball screw, that translates rotational motion to linear motion, a linkage assembly 6400 having, e.g., a scissor jack configuration, and an actuation arm 6212 having a contact portion 6212a such as, e.g., a suction cup, configured to engage the anterior surface “AS” of the patient “P”. The actuator housing 6200 includes a rail 6209 configured to receive a connector of the actuator 6230 to enhance securement of the actuator 6230 to the actuator housing 6200 and guides axial movement of the actuator 6230. In addition, a first portion 6400a of the linkage assembly 6400 is secured to the actuator housing 6200, and a second portion 6400b of the linkage assembly 6400 is movable. The actuator 6230 is operatively coupled to the linkage assembly 6400 via the mechanical linear actuator 6232. The linkage assembly 6400 provides mechanical advantage, which in turn, reduces the amount of load required on the actuator 6230.

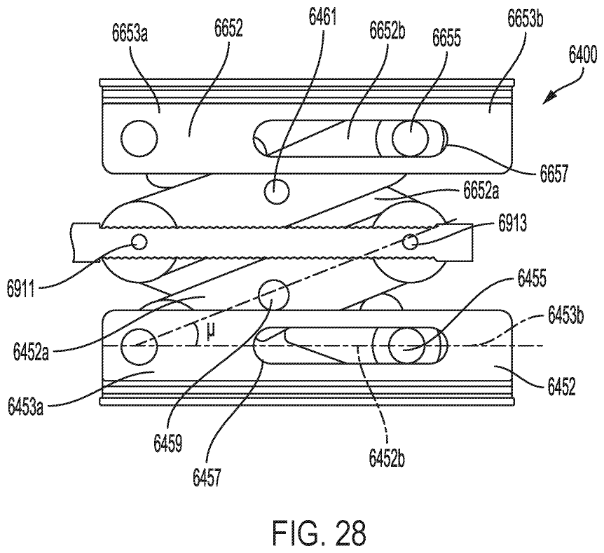

With reference to FIG. 28, the linkage assembly 6400 includes a first plate 6452 having first arm 6452a pivotably coupled to a first end 6453a of the first plate 6452 and a second arm 6452b having a pin 6455 cammingly received in a cam slot 6457 defined adjacent a second end 6453b of the first plate 6452. The first and second arms 6452a, 6452b are pivotably connected about a pivot 6459. The linkage assembly 6400 further includes a second plate 6652 having third arm 6652a pivotably coupled to a first end 6653a of the second plate 6652, and a fourth arm 6652b having a pin 6655 cammingly received in a cam slot 6657 defined adjacent a second end 6653b of the second plate 6652. The third and fourth arms 6652a, 6652b are pivotably coupled about a second pivot 6461. Further, the second arm 6452b and the fourth arm 6652b are pivotably coupled about a third pivot 6911 (shown in phantom) and the first arm 6452a and the third arni 6652a are also pivotably coupled about a fourth pivot 6913 (shown in phantom). In addition, the mechanical linear actuator 6232 extends through the third and fourth pivots 6911, 6913 and is operatively coupled to at least the second and fourth arms 6452b, 6652b such that axial travel of the mechanical linear actuator 6232 causes the third and fourth pivots 6911, 6913 to move between an approximated position and a spaced apart position. The first plate 6452 is coupled to the actuation arm 6212 (FIG. 27) to impart axial movement to the actuation arm 6212 as a single construct. In this manner, when the third and the fourth pivots 6911, 6913 are approximated, the first and second plates 6452, 6652 move away from each other, which in turn, enables the contact portion 6212a of the actuation arm 6212 to provide compression to the anterior surface “AS” of the patient “P”. When the third and fourth pivots 6911, 6913 are moved away from each other, the first and second plates 6452, 6642 move towards each other, which in turn, enables the contact portion 6212a of the actuation arm 6212 to provide decompression to the anterior surface “AS” of the patient “P”. Accordingly, based on the rotational output of the actuator 6230, the contact portion 6212a may achieve compression or decompression on the anterior surface “AS” of the patient “P”. In an implementation, the actuation assembly 6210 may achieve, e.g., a maximum compression depth of about 4 inches (about 102 mm) and a maximum lift above the neutral point of about 1 inch. In another implementation, the first arms 6452a, 6452b may each define, e.g., an acute, angle μ with the first plate 6254. For example, the acute angle μ may range between about 25 degrees and about 66.5 degrees. Utilizing the pin 6455 and the cam slot 6457 allows for a controlled minimum and/or maximum displacement of the lift, and minimum and/or maximum angle μ. Each pinned hinge arm of the linkage assembly 6400 and the size of the cam slot 6457 may determine the horizontal and vertical loads on the actuator 6232.

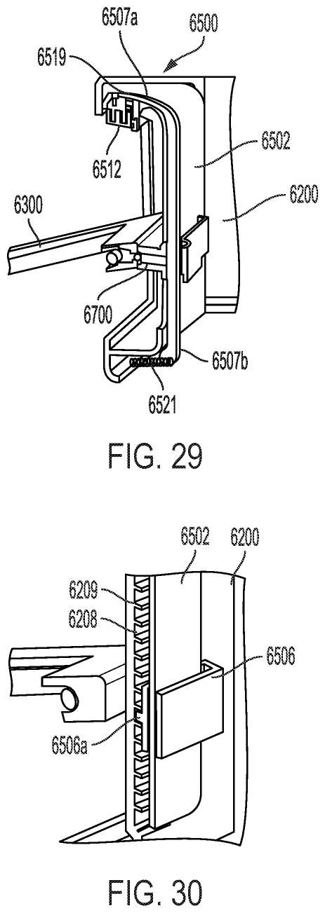

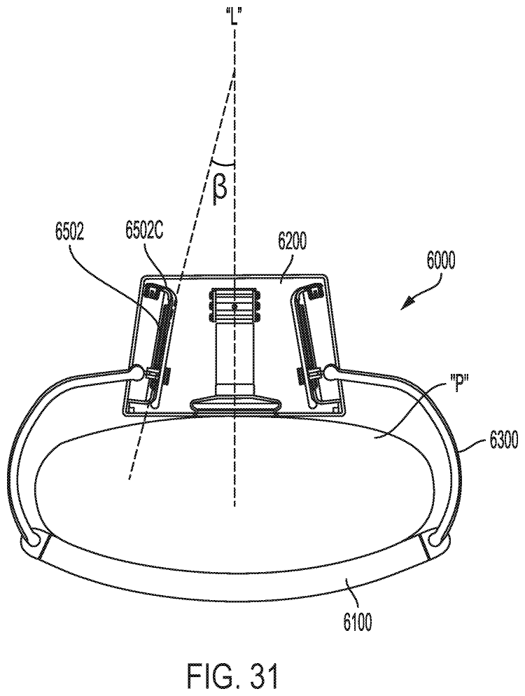

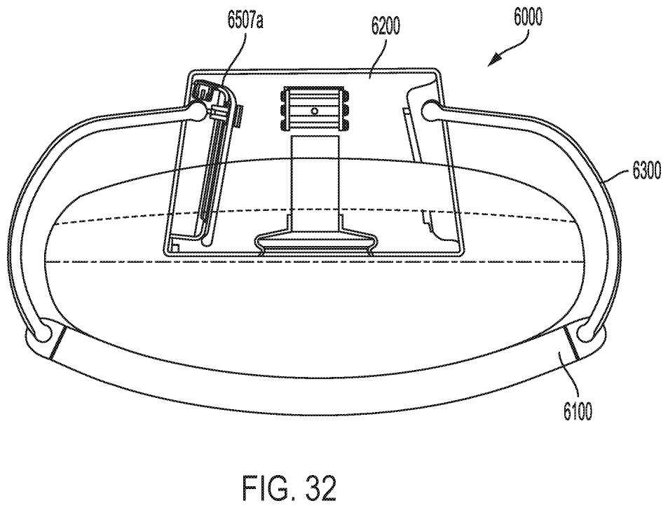

With reference to FIGS. 29 and 30, the adjustment assembly 6500 enables the user to adjust the position of the actuation housing 6200 relative to the base 6100 based on the size of the patient “P”. Components of the adjustment assembly 6500 on opposing sides of the actuation housing 6200 mirror each other. Thus, only one side of the adjustment assembly 6500 is described herein to avoid obscuring the present disclosure in unnecessary detail. The adjustment assembly 6500 includes a locking bar 6502 having an engaging portion 6506 having a tooth 6506a (FIG. 30) on a first side and a connector 6700 (FIG. 29) on a second side thereof. The tooth 6506a is configured to engage one of the plurality of teeth 6209 (FIG. 30) formed on an inner wall 6208 of the actuation housing 6200. The connector 6700 is configured to, e.g., hingedly, couple the first or second portion 6300a. 6300b (FIG. 26) of the support frame 630) to a corresponding locking bar 6502. The inner wall 6208 further includes a lever 6512 that is coupled to the locking bar 6502 via a spring 6519 such that the locking bar 6502 is biased towards a portion of the inner wall 6208 having the plurality of teeth 6209. Under such a configuration, the tooth 6506a is transitionable between an engaged state, in which, the tooth 6506a is biased to engage one tooth of the plurality of teeth 6209 of the inner wall 6208, and a disengaged state, in which, the lever 6512 is depressed which moves the locking bar 6502 away from the inner wall 6208. In the disengaged state, the engaging portion 6506 having the tooth 6506a may be movable along the locking bar 6502. When the tooth 6506a of the engaging portion 6506 is released from the plurality of teeth 6209, the actuation housing 6200 may be movable relative to the first or second portion 6300a, 6300b (FIG. 26) of the support frame. In this manner, the contact portion 6212a (FIG. 27) may be placed in contact with the anterior surface “AS” of the patient “P”. For example, the actuation housing 6200 may be moved away from the base 6100 for a larger patient, e.g., in a case of a patient “P” with a 310 mm chest height, as shown in FIG. 31. For example, the actuation housing 6200 may be moved towards the base 6100, e.g., in a case of a smaller patient “P”. e.g., in a case of a patient “P” with a 165 mm chest height, as shown in FIG. 32.

In some implementations, the inner wall 6208 and the locking bar 6502 may define an acute angle β (FIG. 31) with respect to a longitudinal axis “L-L” (FIG. 31) defined by the actuation arm 6212. In other implementations, the locking bar 6502 may include an arcuate portion 6502c (FIG. 31). The spring 6519 (FIG. 29) may couple the lever 6512 to the arcuate portion 6502c of the locking bar 6502. In other implementations, the adjustment assembly 6500 may further include an auxiliary spring 6521 (FIG. 29) to counterbalance the spring 6519 (FIG. 29) and facilitate disengagement of the locking bar 6502 away from the plurality of teeth 6209 (FIG. 30). For example, the spring 6519 may be disposed at a first end 6507a (FIG. 29) of the locking bar 6502 and the auxiliary spring 6521 may be disposed at a second end 6507b (FIG. 29) of the locking bar 6502.

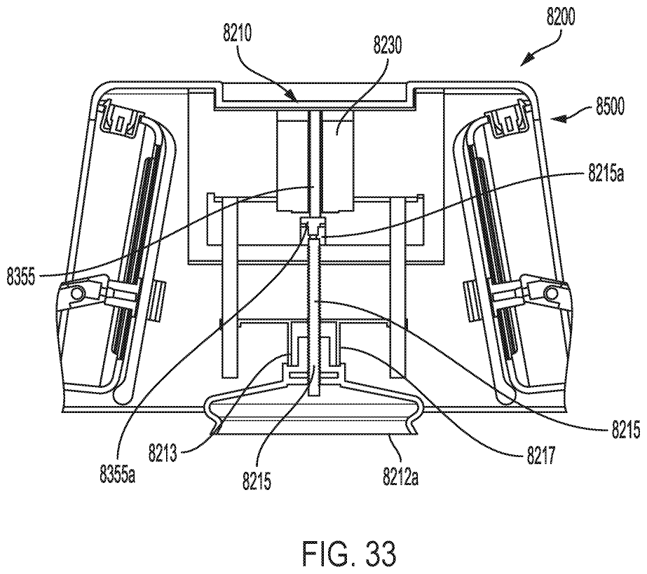

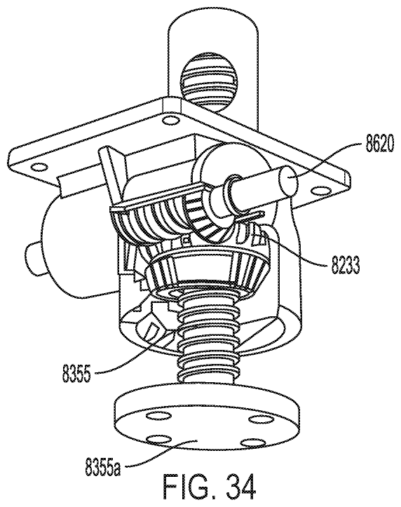

FIG. 33 shows one implementation of an actuation housing 8200 having an actuation assembly 8210 for use with the mechanical chest compression system 6000 (FIG. 32). In contrast to the actuator housing 6200 having the linkage assembly 6400, the actuation assembly 8210 provides a screw jack configuration.

The actuation assembly 8210 may include an actuator 8230, a worm screw 8620 coupled to the actuator 8230 to receive rotational output of the actuator 8230, a worm gear 8233 configured to engage the worm screw 8620 to convert rotational output of the actuator 8230 into a linear motion, a first drive screw 8355, and a second drive screw 8215. The worm gear 8233 is coupled to the first drive screw 8355 to impart rotation to the first drive screw 8355. The first drive screw 8355 includes a connection portion 8355a that is connected to a connection portion 8215a of the second drive screw 8215 to impart rotation to the second drive screw 8215 as a single construct. The contact portion 8212a includes an adapter portion 8213 that threadably engages a second drive shaft 8215. The actuator housing 8200 defines a groove 8217 configured to slidably receive and guide the adapter portion 8213. Under such a configuration, rotation of the second drive screw 8215 causes axial movement of the contact portion 8212a. The actuation housing 8200 may include an adjustment assembly 8500 similar to the adjustment assembly 6500 described hereinabove. In some implementations, the actuator 8230 and the worm screw 8620 may be disposed on the base, whereby the center of gravity of the mechanical chest compression system is lowered.

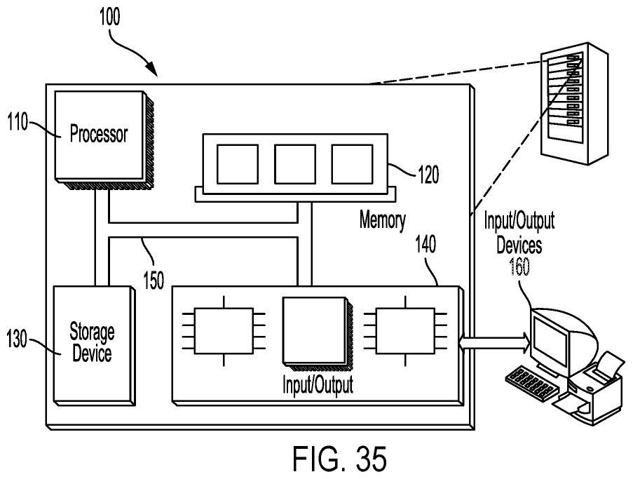

FIG. 35 is a block diagram of an example computer system 100. For example, referring to FIG. 1, the mechanical chest compression system 1000 could be an example of the system 100 described here, as could the external device 412 (FIG. 6). The system 100 includes a processor 110, a memory 120, a storage device 130, and one or more input/output interface devices 160. Each of the components 110, 120, 130, and 140 can be interconnected, for example, using a system bus 150.

The processor 110 may be an example of the processor 400 shown in FIG. 4 and may be capable of processing instructions for execution within the system 100. The term “execution” as used here refers to a technique in which program code causes a processor to carry out one or more processor instructions. In some implementations, the processor 110 may be a single-threaded processor. In some implementations, the processor 110 may be a multi-threaded processor. In some implementations, the processor 110 may be a quantum computer. The processor 110 may be capable of processing instructions stored in the memory 120 or on the storage device 130. The processor 110 may execute operations such as determining a neutral position of chest compression based at least in part on a feature of a compliance curve.

The memory 120 stores information within the system 100. In some implementations, the memory 120 is a computer-readable medium. In some implementations, the memory 120 is a volatile memory unit. In some implementations, the memory 120 is a non-volatile memory unit. The storage device 130 is capable of providing mass storage for the system 100. In some implementations, the storage device 130 is a non-transitory computer-readable medium. In various different implementations, the storage device 130 may include, for example, a hard disk device, an optical disk device, a solid-date drive, a flash drive, magnetic tape, or some other large capacity storage device. In some implementations, the storage device 130 may be a cloud storage device, e.g., a logical storage device including one or more physical storage devices distributed on a network and accessed using a network. In some examples, the storage device may store long-term data. The input/output interface devices 140 provide input/output operations for the system 100. In some implementations, the input/output interface devices 140 can include one or more of a network interface devices, e.g., the wireless communication module 410 shown in FIG. 6, or an Ethernet interface, a serial communication device, e.g., an RS-232 interface, and/or a wireless interface device, e.g., an 802.11 interface, a 3G wireless modem, a 4G wireless modem, etc. A network interface device allows the system 1100 to communicate, for example, transmit and receive data.

In some implementations, the input/output device can include driver devices configured to receive input data and send output data to other input/output devices, e.g., keyboard, printer, display devices 160, patient monitors, defibrillators, ventilators, handheld devices, or other medical devices that may interoperate with the mechanical chest compression system in a closed-loop or synchronized therapy mode. In some implementations, mobile computing devices, mobile communication devices, and other devices can be used. Referring to FIG. 6, steps carried out by the processor 400 can be realized by instructions that upon execution cause one or more processing devices to carry out the processes and functions described above, for example, determining information relevant to a CPR treatment. Such instructions may include, for example, interpreted instructions such as script instructions, or executable code, or other instructions stored in a computer readable medium.

Although an example processing system has been described in FIG. 35, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server (e.g., is a general purpose computer, and sometimes it is a custom-tailored special purpose electronic device, and sometimes it is a combination of these things. Implementations can include a back end component, e.g., a data server, or a middleware component. e.g., an application server, or a front end component. e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of implementations have been described. For example, the detailed description and the accompanying drawings to which it refers are intended to describe some, but not necessarily all, examples or embodiments of the system. The described embodiments are to be considered in all respects only as illustrative and not restrictive. Nevertheless, it will be understood that various modifications may be made without departing from the spirit and scope of the data processing system described herein. Accordingly, other embodiments are within the scope of the following claims.

1. A mechanical chest compression system for performing cardiopulmonary resuscitation comprising:
a resuscitation device including:
a base;
a contact portion configured to be in a superposed relation with an anterior surface of a patient when the patient is disposed on the base, the contact portion being movable relative to the base to provide compression and decompression to the anterior surface of the patient; and
a force sensor configured to generate a force signal during compression and decompression of the anterior surface of the patient; and
a controller operatively coupled to the resuscitation device, the controller including;
a non-transitory computer readable storage medium encoded with a computer program; and
a processor configured to:
receive the force signal generated by the force sensor;
estimate chest compliance relationship using the force signal; and
generate instructions using the chest compliance relationship to drive the contact portion to provide compression and decompression to the anterior surface of the patient,
wherein the computer program of the non-transitory computer readable storage medium comprises instructions that, when executed, cause the processor to perform operations comprising determining the chest compliance relationship based on force applied to the anterior surface of the patient by the contact portion detected by the force sensor, and displacement between an initial position and at least one preset position.

2. (canceled)

3. The mechanical chest compression system according to claim 1, wherein the processor is configured to determine a force to be applied to the anterior surface of the patient in order for the contact portion to reach a target position, based on the chest compliance relationship of the patient.

4. The mechanical chest compression system according to claim 3, wherein the processor is further configured to actuate the resuscitation device to apply the force to the anterior surface of the patient to move the contact portion to the target position.

5. The mechanical chest compression system according to claim 4, wherein a distance between the initial position and the target position has a range between about 2.0 and 2.4 inches.

6. (canceled)

7. The mechanical chest compression system according to claim 1, wherein the resuscitation device includes at least one stop configured to inhibit axial travel of the contact portion, whereby the at least one stop is positioned to enable a preset amount of axial travel of the contact portion.

8. The mechanical chest compression system according to claim 7, wherein the contact portion of the resuscitation device is movable between an initial position and a preset position having a desired compression of the anterior surface of the patient.

9. The mechanical chest compression system according to claim 8, wherein the processor is configured to actuate the resuscitation device to apply a force to the anterior surface of the patient to cause axial travel of the contact portion to the preset position.

10. The mechanical chest compression system according to claim 1, wherein the resuscitation device includes a plurality of stops configured to inhibit axial travel of the contact portion, whereby each stop is positioned to enable a preset amount of axial travel of the contact portion, wherein the contact portion is movable between an initial position and a plurality of preset positions corresponding to a desired compression of the anterior surface of the patient.

11. The mechanical chest compression system according to claim 10, wherein the controller further includes a non-transitory computer readable storage medium encoded with a computer program comprising instructions that, when executed, cause the processor to perform operations comprising:
selecting a stop of the plurality of stops to effect a desired compression of the anterior surface of the patient, the stop corresponding to one preset position of the plurality of preset positions of the contact portion; and
actuating the resuscitation device to apply a force to the anterior surface of the patient to cause axial travel of the contact portion to the one preset position.

12. The mechanical chest compression system according to claim 1, wherein the resuscitation device further includes an actuation arm having the contact portion and the actuation arm is removably attached to the patient by a patient attachment interface.

13-26. (canceled)

27. The mechanical chest compression system according to claim 1, wherein the resuscitation device further includes a displacement sensor.

28. The mechanical chest compression system according to claim 27, wherein the controller further includes a non-transitory computer readable storage medium encoded with a computer program comprising instructions that, when executed, cause the processor to perform operations comprising determining the chest compliance relationship based on force applied to the anterior surface of the patient by the contact portion detected by the force sensor, and displacement measured by the displacement sensor.

29. The mechanical chest compression system according to claim 28, wherein the displacement sensor includes an accelerometer.

30. A system for performing cardiopulmonary resuscitation comprising:
a resuscitation device comprising:
a base;
a frame including arms that are supported by the base;
an actuator coupled to the frame;
an actuation arm supported by the arms of the frame such that the actuation arm is in a superposed relation with an anterior surface of a patient when the patient is disposed on the base of the frame, the actuation arm configured to provide compression and decompression to the anterior surface of the patient, the actuation arm including a first portion configured to be affixed to the anterior surface of the patient and a second portion operatively coupled to the actuator to impart axial travel to the first portion of the actuation arm, wherein the actuation arm is movable between an initial position, a preset position, or a target position having a desired axial travel of the first portion of the actuation arm; and
a force sensor coupled to the actuation arm; and
a controller operatively coupled to the resuscitation device, the controller including a processor and a non-transitory computer readable storage medium encoded with a computer program comprising instructions that, when executed, cause the processor to perform operations comprising:
determining a chest compliance relationship based on force applied to the anterior surface of the patient by the first portion of the actuation arm measured by the force sensor, and displacement between the initial position and the preset position;
based on the chest compliance relationship of the patient, determining a force to be applied to the anterior surface of the patient in order for the actuation arm to reach the target position; and
actuating the resuscitation device to apply the force to the anterior surface of the patient to move the actuation arm to the target position.

31. The system according to claim 30, wherein the force sensor is disposed in the first portion of the actuation arm.

32. The system according to claim 30, wherein the force sensor is disposed adjacent the second portion of the actuation arm.

33. The system according to claim 30, wherein the resuscitation device further includes an outer sleeve configured to slidably receive the actuation arm therein.

34. The system according to claim 33, wherein the outer sleeve includes a stop configured to inhibit axial displacement of the actuation arm therein.

35. The system according to claim 34, wherein the actuation arm includes a tooth configured to engage the stop of the outer sleeve.

36. The system according to claim 35, wherein the actuation arm is rotatable relative to the outer sleeve between an engaged state, in which, the tooth of the actuation arm engages the stop of the outer sleeve and a disengaged state, in which, the tooth of actuation arm is angularly offset from the stop of the outer sleeve to enable axial travel of the actuation arm within the outer sleeve.

37. The system according to claim 34, wherein the preset position of the actuation arm corresponds to an axial location of the stop on the outer sleeve.

38. The system according to claim 34, wherein the stop of the outer sleeve is selectively adjustable along a length of the outer sleeve.

39-49. (canceled)

50. A system for performing cardiopulmonary resuscitation comprising:
a resuscitation device including:
an actuation arm having a first portion configured to be affixed to an anterior surface of a patient and movable to apply compression and decompression to the patient, wherein the first portion is movable during compression and decompression between an initial position, a preset position, or a target position;
at least one stop configured to inhibit axial travel of the actuation arm, whereby the at least one stop is positioned to enable a preset amount of axial travel of the actuation arm between the initial position and the preset position; and
a force sensor coupled to the actuation arm; and
a controller operatively coupled to the resuscitation device, the controller including a processor and a non-transitory computer readable storage medium encoded with a computer program comprising instructions that, when executed, cause the processor to perform operations comprising:
determining a chest compliance relationship involving force applied to the anterior surface of the patient by the first portion of the actuation arm, and displacement between the initial position and the preset position;
based on the chest compliance relationship, determining a force to be applied to the anterior surface of the patient in order for the first portion of the actuation arm to reach the target position; and
actuating the resuscitation device to apply the force to the anterior surface of the patient to move the first portion of the actuation arm to the target position.

51. The system according to claim 50, wherein the force sensor is disposed adjacent the first or second portion of the actuation arm.

52. The system according to claim 50, wherein the preset position is interposed between the initial position and the target position.

53-69. (canceled)

70. A system for performing cardiopulmonary resuscitation comprising:
a resuscitation device comprising:
an actuator;
an actuation arm positionable in a superposed relation with an anterior surface of a patient, the actuation arm configured to provide compression and decompression to the anterior surface of the patient, the actuation arm including a first portion configured to be affixed to the anterior surface of the patient and a second portion operatively coupled to the actuator to impart axial travel to the first portion of the actuation arm; and
at least one stop configured to inhibit axial travel of the actuation arm, whereby the at least one stop is positioned to enable a preset amount of axial travel of the actuation arm, wherein the actuation arm is movable between an initial position and a preset position having a desired compression of the anterior surface of the patient; and
a controller operatively coupled to the resuscitation device, the controller including a processor and a non-transitory computer readable storage medium encoded with a computer program comprising instructions that, when executed, cause the processor to actuate the resuscitation device to apply a force to the anterior surface of the patient to cause axial travel of the actuation arm to the preset position.

71-72. (canceled)

73. The system according to claim 70, wherein the resuscitation device further includes an outer sleeve configured to slidably receive the actuation arm therein.

74. The system according to claim 73, wherein the outer sleeve includes the at least one stop configured to inhibit axial displacement of the actuation arm therein.

75. The system according to claim 74, wherein the actuation arm includes a tooth configured to engage the at least one stop of the outer sleeve.

76. The system according to claim 75, wherein the actuation arm is rotatable relative to the outer sleeve between an engaged state, in which, the tooth of the actuation arm engages the at least one stop of the outer sleeve and a disengaged state, in which, the tooth of actuation arm is angularly offset from the at least one stop of the outer sleeve to enable axial travel of the actuation arm within the outer sleeve.

77. The system according to claim 74, wherein the preset position of the actuation arm corresponds to an axial location of the at least one stop on the outer sleeve.

78-120. (canceled)

121. A system for performing cardiopulmonary resuscitation comprising:
a resuscitation device including:
an actuation arm having a first portion configured to be affixed to an anterior surface of a patient and movable to apply compression and decompression to the patient, wherein the first portion is movable during compression from an initial position to a first target position and decompression from the first target position to a second target position;
at least one stop configured to inhibit axial travel of the actuation arm, whereby the at least one stop is positioned to enable a preset amount of axial travel of the first portion of the actuation arm between the initial position and a preset position; and
a force sensor operatively coupled to the actuation arm; and
a controller operatively coupled to the resuscitation device, the controller including a processor and a non-transitory computer readable storage medium encoded with a computer program comprising instructions that, when executed, cause the processor to perform operations comprising:
determining a chest compliance relationship involving force applied to the anterior surface of the patient by the first portion of the actuation arm, and displacement between the initial position and the preset position;
based on the chest compliance relationship, determining a compression force to be applied to the anterior surface of the patient in order for the first portion of the actuation arm to reach the first target position;
based on the chest compliance relationship, determining a decompression force to be applied to the anterior surface of the patient in order for the first portion of the actuation arm to retract to the second target position;
actuating the resuscitation device to apply the compression force to the anterior surface of the patient to cause axial displacement of the first portion of the actuation arm to the first target position to perform compression; and
actuating the resuscitation device to apply the decompression force to the anterior surface of the patient to cause axial displacement of the first portion of the actuation arm to the second target position to perform decompression.

122. The system according to claim 121, wherein the decompression force is a negative force.

123. The system according to claim 121, wherein the second target position is different from the initial position.

124. The system according to claim 121, wherein the second target position is distal of the initial position.

125. The system according to claim 121, wherein the operations of the processor further comprise determining a second chest compliance relationship involving a negative force applied to the anterior surface of the patient by the first portion of the actuation arm, and displacement between the initial position and a second preset position.

126. The system according to claim 125, wherein the second preset position is distal of the initial position.

127. The system according to claim 126, wherein the second preset position is proximal of the second target position.

128-152. (canceled)
